(19) United States
(12) Patent Application Publication
(10) Pub. No.: US 2016/0255082 A1
(43) Pub. Date: Sep. 1, 2016

(54) Identifying & storing followers, following users, viewers, users and connections for user

(71) Applicant: Yogesh Rathod, Mumbai (IN)

(72) Inventor: Yogesh Rathod, Mumbai (IN)

(21) Appl. No.: 15/083,371

(22) Filed: Mar. 29, 2016

(30) Foreign Application Priority Data
Mar. 27, 2016 (IB) PCT/IB2016/051739

(51) Int. Cl. H04L 29/06; G06F 17/30; H04L 12/58

(52) U.S. Cl. CPC H04L 63/10; H04L 51/32; G06F 17/30386; G06F 17/3053

(57) ABSTRACT

Various embodiments of a system, methods, platform, social network, database, search engine & device for posting or presenting contents to contextual users of network. In an embodiment server identifies, updates and stores each user specific contextual or matched following users, followers, viewers, category or activity specific users and connections from users of network based on user data and identified, applied & executed rules via rule based system. User is relieve from manually search, match, select or select from directory or suggested list and follow other users of network for receiving contextual contents. Other contextual users of network automatically follow users i.e. server identified and stores user's contextual or matched followers, following users and viewers. So instantly each user can create follower base for posting contents to them and instantly get viewership & reactions on posted contents and instantly follow other contextual users or sources of network for receiving contextual contents.

This is a continuation of International Application PCT/IB2016/051739, with an international filing date of 27 Mar. 2016, having title: Identifying & storing followers, following users, viewers, users and connections for user.

### COPYRIGHTS INFORMATION

A portion of the disclosure of this patent document contains material which is subject to (copyright or mask work) protection. The (copyright or mask work) owner has no objection to the facsimile reproduction by anyone of the patent document or the patent disclosure, as it appears in the Patent and Trademark Office patent file or records, but otherwise reserves all (copyright or mask work) rights whatsoever. The applicant acknowledges the respective rights of various Intellectual property owners.

### FIELD OF INVENTION

The present invention relates generally to identifying, auto identifying, determining, storing contextual followers, following, viewers, one or more types, categories, activities, events, transactions specific contextual users and connections for each user of network based on user data or updated user data, identified rules, ontology, pre-created categories followers, following, viewers and connections.

### BACKGROUND OF THE INVENTION

At present Twitter™, Instagram ™, Facebook™ and other social networks, websites, communication applications and services enable user to manually search, match, select and follow one or more users of network. Some of the social networks, communication applications and services provide suggested users to user so user can select and follow or connect with them. So following to other users of network, creating follower base and connecting with contextual users of network will takes lot of time, money and effort.

None of the social or communication networks, websites, applications & services enables automatically identify, determine, search, match, rank, select contextual followers, following users, viewers, connections and contextual users of network based on users data including user profile, user contents, shared contents, user logs, activities, actions, events, transactions, behavior, senses, interactions, contacts including phone contacts, social contacts or friends, instant messenger contacts, & email contacts, connections, current or past or selected locations & places, updated status or structured status and identified, applied and executed one or more rules via rule base system, identified ontology, semantic syntax, semantic matching, applied server policies & system rules or limits, privacy settings, preferences and pre-created or updated contextual categories followers, following users, viewers, connections and contextual users.

Present invention enables each user to provide user data and based on that server system automatically identify, determine, rank and store each user specific followers, following users, viewers, connections and contextual users. So user can posts one or more types of content or media including text, link, photo, image, video, voice, file & location without identification of an intended one or more recipients and server determine or identify one or more followers, viewers, connections and contextual users based on stored contextual followers, viewers, connections and contextual users and/or server can real-time determine or identify intended one or more recipients based on keywords, key phrases, taxonomy, metadata and categories of posted contents, rank of posting user, updated user data of prospective recipients or users of network and one or more factors and rules.

Therefore, it is with respect to these considerations and others that the present invention has been made.

### OBJECT OF THE INVENTION

The object of the present invention is to enabling to automatically determine, create & store each user specific contextual following users from other users of network, automatically identify, determine, create & store each user specific follower base, automatically identify, determine, create & store viewers, automatically identify, determine, add or update contacts and connect with contextual connections.

The another object of the present invention is to dynamically, real-time and automatically identifying and storing followers and viewers for each user of network based on plurality types of user data or updated user data & user data of related users and identified, applied & executed rules.

### DETAIL DESCRIPTION OF THE PREFERRED EMBODIMENT

The present invention now will be described more fully hereinafter with reference to the accompanying drawings, which form a part hereof, and which show, by way of illustration, specific exemplary embodiments by which the invention may be practiced. This invention may, however, be embodied in many different forms and should not be construed as limited to the embodiments set forth herein; rather, these embodiments are provided so that this disclosure will be thorough and complete, and will fully convey the scope of the invention to those skilled in the art. Among other things, the present invention may be embodied as methods or devices. Accordingly, the present invention may take the form of an entirely hardware embodiment, an entirely software embodiment or an embodiment combining software and hardware aspects. The following detailed description is, therefore, not to be taken in a limiting sense.

Throughout the specification and claims, the following terms take the meanings explicitly associated herein, unless the context clearly dictates otherwise. The phrase “in one embodiment” as used herein does not necessarily refer to the same embodiment, though it may. Furthermore, the phrase “in another embodiment” as used herein does not necessarily refer to a different embodiment, although it may. Thus, as described below, various embodiments of the invention may be readily combined, without departing from the scope or spirit of the invention.

In addition, as used herein, the term “or” is an inclusive “or” operator, and is equivalent to the term “and/or,” unless the context clearly dictates otherwise. The term “based on” is not exclusive and allows for being based on additional factors not described, unless the context clearly dictates otherwise. In addition, throughout the specification, the meaning of “a,” “an,” and “the” include plural references. The meaning of “in” includes “in” and “on.”

As used herein, the term “receiving” posted or shared contents & communication and any types of multimedia contents from a device or component includes receiving the shared or posted contents & communication and any types of multimedia contents indirectly, such as when forwarded by one or more other devices or components. Similarly, “sending” shared contents & communication and any types of multimedia contents to a device or component includes sending the shared contents & communication and any types of multimedia contents indirectly, such as when forwarded by one or more other devices or components.

As used herein, the term “client application” refers to an application that runs on a client computing device. A client application may be written in one or more of a variety of languages, such as ‘C’, ‘C++’, ‘C#’, ‘J2ME’, Java, ASP.Net, VB.Net and the like. Browsers, email clients, text messaging clients, calendars, and games are examples of client applications. A mobile client application refers to a client application that runs on a mobile device.

As used herein, the term “network application” refers to a computer-based application that communicates, directly or indirectly, with at least one other component across a network. Web sites, email servers, messaging servers, and game servers are examples of network applications.

Embodiments described herein enabling server system to auto identified each user of network specific followers, following users, connections, viewers and one or more types or categories or activities specific matched or contextual users from users of network based on user data and identified, applied and executed rules and enabling user(s) to receive contents from auto identified or determined or stored sources or users of network. There is no need for user to manually search, match, browse, select or select from suggested list and manually follow one or more users of network. Server system enabling to present posted contents of users of network to said each posting user specific identified and stored intended recipient(s) or viewer(s) or connection(s) or matched contextual users.

In an embodiment a computer-implemented method comprising: identify or determine, by the server system, each user specific other users of network including followers, following users, viewers, group members, connections, contacts, domain or subject specific contextual users, participants for conducting one or more types of communications, collaborations, sharing, activities, actions, events, tasks & transactions, provider or consumer of user services, wherein user is not connected with or not manually following to said identified other users of network previously or mutually connected or mutually not connected with each other; store, by the server system, each user specific said one or more types of identified other users of network; and enable user, by the server system, to post content item(s) which lacks identification of an intended recipient(s), wherein server identifies and present content item(s) to intended recipients based on said identified other users of network and/or enable user, by the server system to communicate, collaborate, share, connect, conduct or participate with one or more types of one or more activities, actions, events & transactions, and provide or consume one or more user services with/from/to said identified one or more other users of network.

In an embodiment present one or more types of one or more content items or media including text, link, photo, image, video, voice, location information, documents or file, attachment and any combination thereof to intended recipients comprises followers, viewers, contacts identified or determined by the server system or stored by the server system at database(s).

In an embodiment identify or determine, by the server system, each user specific other users of network based on user data, wherein user data comprise user profile including age, gender, interest, school, college, employer, company, skills, languages, education, qualifications, income range, habits, religion, height, weight, cast & like, user activities, actions, events, transactions, senses, interactions, behavior, interacted entities, locations, places, contacts or connections, status, structured status, key phrases, keywords, categories, preferences, shared contents, viewed contents, subscribed contents, filled domain or subject or requirement or activities specific forms, one or more types of lists including products and services using or like to use and privacy settings.

In an embodiment broadcast request comprise one or more type of content or media and associate one or more target criteria for matching of content, posting or broadcasting user data and one or more associated target criteria of posting user with user data of other users of network, wherein posting or communicating target criteria comprise one or more keywords, categories, types, locations, places, age range, gender, entity names & types, interests, languages, include or exclude IP address, destinations & one or more type of criteria and user data comprise user profile, logged activities, actions, events, transactions, locations, places, status, preferences, privacy settings, search query, keywords, past views of contents.

In an embodiment enable server system to update each user's followers, following users, viewers or prospective viewers, prospective connections or contacts and one or more types or categories of matched in the event of one or more updates in one or more users of network's user data provided by user, contacts or connections of users, 3rd parties, and auto identified by server system, wherein at particular interval of period of time or based on user's current or selected one or more locations, places, activities, actions, events & transactions alerting or notifying or make compulsory for each user to update user profile, requested one or more types of information and user data within particular period of time and in the event of providing of requested user data by user, allowing user to access system.

In an embodiment displaying one or more fields or sub-filed(s) specific, one or more metadata of one or more fields or sub-filed(s) specific, one or more values of one or more fields or sub-filed(s) and any combination thereof specific number of prospective followers, following users, viewers, connections or contacts, possible average or estimated reactions and contextual one or more types of matched users of network.

In an embodiment enabling user and user related server identified or determined contextual or matched one or more types of one or more users including one or more followers, following users, viewers, and connections to communicate, collaborate, share, conduct or participate with one or more activities, actions, events & transactions and provide or consume services by using one or more types of one or more applications, interfaces, user actions, widgets, set of controls, objects, web sites, web pages and web services or user services including real-time chat, instant messaging, collaboration application, mutual following, and invite to connect.

In an embodiment enable following or un-following, followers and broadcasting or providing or presenting contents based on rules, policies, privacy settings, preferences and server rules & settings, wherein one or more rules including not allowing user to manually un-follow sources, allowing user to manually follow to contacts or connected users only including phone contacts, email addresses via email accounts, and social friends or connections, limit maximum numbers of auto followers based on number of following users and number of followers, limit number of maximum content items received or presented to user from all or each sources within particular period of time based on number of followers of user, daily engagement or number of viewing of content items within particular period of time, bookmarked or liked or ranked sources or sources of liked or ranked contents, user contacts, allow user to set maximum number of content item within particular period of time including (per minute, hour, daily, monthly) or time ranges from all or one or more selected or particular or categories of sources, limit maximum number of posting of content items within particular period of time, limit receiving of maximum number of content items from all or particular or one or more selected sources or category or keyword(s) or field specific sources, allow to un-follow after reaching particular number of following users or sources, fill or provide value(s) of particular number of field(s) of profile in particular interval of period of time, ratio of followers and following, enable user to un-follow one or more sources including enable to un-follow one or more sources by permitted users only, enable to un-follow one or more sources based on maximum limits of particular number of un- following of sources permitted within particular duration, request server to un-follow one or more sources with reason(s), report one or more sources as spam or inappropriate content(s), the server system is enable to auto un-follow user(s) to one or more followed sources based on updated user data, number of posts within particular period of time by sources, number of user actions, number of views, number of likes, number of comments, number of dislikes, number of reports and any combination of thereof.

In an embodiment a computer-implemented method for facilitating user-to-user communication in a network environment, the method comprising: receiving, by a server system from first computing devices on behalf of a plurality of users in the network environment, herein called “viewing users”, a corresponding plurality types of user data; storing, by a server system each user related user data in a storage; identifying, by a server system each user specific list of followers, following users, viewers and one or more types of contextual or matched users or sources based on user data and/or identified, associated, applied and executed one or more rules via rule base system, ontology, semantic syntax, semantic matching, contextual users or sources from pre-created categories of sources or users, user followed or subscribed or likes or requested sources, and user contacts or connections; storing, by a server system in a storage each user specific said list of followers, following users, viewers and one or more types of contextual or matched users or sources; receiving, by the server system from a second computing device on behalf of a user in the network environment, herein called the “broadcasting user”, a broadcast request or posting request to broadcast or post a specific item(s) of content, wherein the broadcast or posting request lacks identification of an intended recipient, and wherein the broadcast or posting request includes an identification of the broadcasting or posting user; and determining or identifying, by the server system, in response to the broadcast request, based on identified or determined one or more intended recipients as applied to the broadcast request, any viewing users then eligible to receive the specific item of content(s).

The invention as claimed has utility in that it enables real-time contextually following and search followers for user and connecting with other users of network in plurality of ways or for plurality of possible requirements, needs, activities, actions, events, transactions & tasks based on plurality of factors & contexts. For example:

In an another example connect, auto following or auto find followers for user who provide user data e.g. structured status with television or stadium viewers of particular sports at particular date & time e.g. cricket, soccer, football, baseball, Olympics for sharing comments, experience, views and scores. Based on user's structured status or activity provided or updated by user e.g. “viewing 20-20 cricket match between India and Australia”, server system identifies current location or place of user (e.g. location of stadium to identify stadium viewers or non-location of stadium to identify television viewers), current date & time, user data and rules and identifies television or stadium viewers of particular sports. So user can connect, allow to follow and follow with selected all matched viewers and select or access presented application e.g. instant messenger, so user can share comments, experience and scores.

In an another example connect and follow who provide or update user data with users who entered in to R-mall™ for determining prospective customers and make offers—As per rule system identifies user's role or job or business from profile e.g. user is seller and have particular type of shop in R-mall™. Based on user's location or status or activity server system identifies that user or prospective customers is entering in R-mall and have intention to shop or shop particular brand or product. So based on rule and user data, location, current status, server system matches entered users with said seller user and connect or follow them with each other.

In an another example connect and follow user with users who are using Colgate™ as toothpaste for sharing reviews and suggesting alternatives, sharing health effect etc.—Based on user activity i.e. “ I m using Colgate™” and “I want to use Coalgate™” system matches actual users with prospective users for sharing experience, answering queries etc.

In an another example connect and follow user with users with provider of particular product(s) and/or service(s) who offers lowest price—Based on user updated in user data e.g. “I want to buy Samsung s6™ at lowest possible price”—system identifies buying interest of particular brand name and connect or follow with users who sell said brand based on profile data or status e.g. Seller of Samsung s6™ at Mumbai and “lowest price selling Samsung s6™ Rs. 35k” etc.

By analyzing user data including identifying ontology, name, entity, type, product, service, brand, event name, movie name, keywords (e.g. buy, sell, view, eat, review, like, customer etc.), type of purpose, activity, status (viewing, eating, reading, listening,), user profile field (e.g. age, gender, name, contact name) and associate rules system identifies following or connection need of user with other contextual users of network. For example if “Buyer” then look for “Seller”, if “Patient” then connect or follow with contextual doctors, medical store representatives, canteen administrator, nurse, helper, nearest availed cab driver etc., if “Student” then connect or follow with other student, teachers, classes, stationery shops etc., if user entering mall and want to do particular activity (e.g. view movie then connect with other viewers of movie, but if buyer then connect or follow with seller or similar buyer or if advertiser then connect with or become follower of advertiser to all entered users or if staff then connect or follow with other staff or if distributer then connect or following with contextual shops or make them following to distributor etc.)

In an another example server system 110 or user is enable to create and update one or more listings, calendar items, keywords, key phrases, hash tags, categories related to one or more activities, actions, events, location & place and provide associate details including event location & place, date & time e.g. event date & time, and event details which server 110 stores at database 115. The server system 110 stores users who want to attend or are doing or attending or want to doing or attending or currently doing or attending one or more activities or event(s) stored at database 115 by server 110. In an embodiment server 110 automatically identify users who currently doing or attending one of the activity listed or stored by server 110 based on matching one or more users' auto identified or current or selected or check-in location or place information, profile data, user data, updated status & presence information with said stored activity related date & time, details and precise location or place and auto identify and store said identified each user and based on that identify and store each user specific and advertiser or sponsored e.g. organizer of said event specific followers and following. In an embodiment server also identified each user specific followers related to said event including user contacts, connections, contextual past followers, contextual followers and viewers from other users of network, so said user also receive feeds or posted content items from event attending user(s). After determining finishing of an event based on said stored start and ending date & time of particular event or activity and associated stored details, server system 110 auto un-following each user and/or allow to manually select and follow said event related followers and organizer(s) of event or advertiser(s). So server system 110 enables to dynamically follow and un-follow users of network based on stored activities, actions, events, transactions, locations, places and associate details including start & end date & times or ranges of date & time, associated details. In an embodiment there are plurality of ways where users can dynamically, automatically & real-time follow and un-follow to contextual users e.g. during or up-to end of particular movie or sports event or drama or event follow each or contextual or matched viewer(s) or participant(s) or member(s) or attendee(s) or visitor(s) or guest(s) by each other or contextual or matched viewer(s) or participant(s) or member(s) or attendee(s) or visitor(s) or guest(s).

In an embodiment server system creates accounts and update and stores details for one or more companies, celebrities, experts, selective people, brands, products, shops, sellers, and service providers and enable them to request to server system 110 to claim their one or more account(s) or server system 110 send invitation e.g. via SMS or phone call or via email or any other communication medium for inviting them to join or use already created account(s).

In an embodiment enabling server system 110 to dynamically present number of content item within particular period of time e.g. real-time, hourly, daily, based on user's daily or monthly or particular period of time or rang of time number of engagements, interactions with viewed contents of other users including likes, ratings, comments, re-shares, & one or more types of user actions, number of followers, number of views, number of following users, number of viewers, number of contacts or friends or connections.

In an embodiment server system 110 to dynamically determined presenting of user's posted content items to one or more followers and restrict presenting to other remaining followers or partially present posted content(s) or number of posted contents to followers, wherein determining or further filtering followers for presenting them to posted content item by said posting user based on each follower's past number of interactions on contents posted by said posting user including number of likes, comments, reply, re-share, rank & user actions, user liked sources, matching keywords of each posted content with user data of each follower, viewer and user contacts, number of daily engagement of each follower, number of daily posts by posting user, rank of posting user, rank of follower or viewing user, current status, updated status, presence information, current location, place, activity, action, event & transaction.

In various examples there are pluralities of ways to identify contextual followers for each user of network. For example based on combinations or permutations or categories rank wise combinations of user's one or more profile attributes or fields and/or values for example combination of user's location, gender, age range, interests, activities and school identify followers or following users, based on type of position or role, department, skills and company name or category identify followers or following users, based on location, and income range identify followers or following users, based on user related products, services, one or more type of entities and associate one or more types of relationship identify followers or following users.

In computer science, rule-based systems are used as a way to store and manipulate knowledge to interpret information in a useful way. They are often used in artificial intelligence applications and research. A classic example of a rule-based system is the domain-specific expert system that uses rules to make deductions or choices. For example, an expert system might help a doctor choose the correct diagnosis based on a cluster of symptoms, or select tactical moves to play a game. Rule-based systems can be used to perform lexical analysis to compile or interpret computer programs, or in natural language processing. Rule-based programming attempts to derive execution instructions from a starting set of data and rules. This is a more indirect method than that employed by an imperative programming language, which lists execution steps sequentially.

In an embodiment a typical rule-based system has four basic components: A list of rules or rule base, which is a specific type of knowledge base. An inference engine or semantic reasoner, which infers information or takes action based on the interaction of input and the rule base. The interpreter executes a production system program by performing the following match-resolve-act cycle: Match: In this first phase, the left-hand sides of all productions are matched against the contents of working memory. As a result a conflict set is obtained, which consists of instantiations of all satisfied productions. An instantiation of a production is an ordered list of working memory elements that satisfies the left-hand side of the production. Conflict-Resolution: In this second phase, one of the production instantiations in the conflict set is chosen for execution. If no productions are satisfied, the interpreter halts. Act: In this third phase, the actions of the production selected in the conflict-resolution phase are executed. These actions may change the contents of working memory. At the end of this phase, execution returns to the first phase. Temporary working memory. A user interface or other connection to the outside world through which input and output signals are received and sent.

In an embodiment a business rules engine is a software system that executes one or more business rules in a runtime production environment. The rules might come from legal regulation (“An employee can be fired for any reason or no reason but not for an illegal reason”), company policy (“All customers that spend more than $100 at one time will receive a 10% discount”), or other sources. A business rule system enables these company policies and other operational decisions to be defined, tested, executed and maintained separately from application code. Rule engines typically support rules, facts, priority (score), mutual exclusion, preconditions, and other functions. Rule engine software is commonly provided as a component of a business rule management system which, among other functions, provides the ability to: register, define, classify, and manage all the rules, verify consistency of rules definitions (“Gold-level customers are eligible for free shipping when order quantity >10” and “maximum order quantity for Silver-level customers=15”), define the relationships between different rules, and relate some of these rules to IT applications that are affected or need to enforce one or more of the rules. In any IT application, business rules can change more frequently than other parts of the application code. Rules engines or inference engines serve as pluggable software components which execute business rules that a business rules approach has externalized or separated from application code. This externalization or separation allows business users to modify the rules without the need for IT intervention. The system as a whole becomes more easily adaptable with such external business rules, but this does not preclude the usual requirements of QA and other testing.

In an embodiment the same user can have many profiles. At a given point in time, one of these profiles is the one corresponding to the current user's activity and request. Tables 1 and 2 show two possible profiles for the same person, the former relates to his role as a tourist, the latter relates to his role as a computer science professional. User profiles can be organized into two parts, a static part and a dynamic part. The static part stores the information that is seen as inherently related to the user, irrespectively of what are his/her current activity and interest, e.g. age and nationality. The dynamic part contains information closely related to the user's possible activities and requests.

For example Tables 1 (User Profile (a))—Activity: Tourist, Profession: {professor, employee, academic}, Age: senior, Gender: male, Nationality: French, Income: good, Interest: art, culture, hiking, cinema, Languages: French, English, Italian, Food: good, very good, Cuisine: Japanese, Thai, Arabic, Argentinean, Credit cards: VISA, Master Card

For example Tables 2 (User Profile (b))—Activity: Professional, Profession: {computer scientist, professor}, Age: senior, Interest: databases, ontologies, semantic web, Languages: French, English, Italian, Memberships: ACM, IEEE, IFIP, SI

Example of Data profile for a restaurant—Location: Geneva, Cuisine: {international, Japanese}, Price range: 25-45 CHF, Opening hours: 11:30 am-2 pm, 6:30 pm-10 pm, Situation: {indoor, outdoor}, Smoking: {smoking, non-smoking}, Parking: no, Credit cards: VISA, Master Card

In the example profiles for user[Y], the properties ‘age’, ‘gender’, ‘nationality’, ‘income’ and ‘languages’ would belong to the static and general part, while ‘activity’, ‘profession’, ‘interest’, ‘food’, ‘cuisine’, and ‘credit cards’ would belong to the dynamic part. Especially, when the user wants to find a restaurant, the ‘cuisine’ can be referred for selection and the credit card can be one prerequisite for reservation. It can be noted that even though some attributes are repeated in both profiles, such as ‘age’ and ‘languages’, their effect is different in both activities. In addition, some attributes have different values, such as ‘profession’ and ‘interest’. Hence, in an activity-based profile modeling approach or in this model, a user has a complete profile, and one or many activity profiles. Each attribute in the complete profile has an annotation to indicate what activity it is associated with, when and where it should be used, what other attributes are highly concerned with in the same activity etc. When the user sends a query, one activity profile is dynamically created by retrieving the corresponding attributes from the complete profile (using the annotations) as shown above. User profiles are composed of very personalized information on user preferences and activities. The understanding and definitions of properties in user profiles depends on the culture, language, education, etc. For users on the move, it is annoying to adapt their profile according to local languages or habits. Using ontologies could be one solution since they provide general and shared common definitions.

In the COSS (Context-aware, Ontology-based, Semantic Service discovery) system, service providers and context providers use domain-specific ontologies to which they commit. These ontologies are: the service type ontology (containing concepts such as shop, restaurant), the product ontology (containing concepts such as DVD, vegetarian food), the payment ontology (containing concepts such as cash, credit card), and the context ontology (containing concepts such as location, time). The TIP (Tourism Information Provider) system allows end users to get relevant information based on their current location and the current time (besides to their profile and their history).

The present invention may uses Rule based systems and the same is described hereunder.

In computer science, rule-based systems are used as a way to store and manipulate knowledge to interpret information in a useful way. They are often used in artificial intelligence applications and research.

A classic example of a rule-based system is the domain-specific expert system that uses rules to make deductions or choices. For example, an expert system might help a doctor choose the correct diagnosis based on a cluster of symptoms, or select tactical moves to play a game.

Rule-based programming attempts to derive execution instructions from a starting set of data and rules, which is a more indirect method than using a programming language which lists execution steps straightforwardly.

A typical rule-based system has four basic components:
(1) A list of rules or rule base depending upon the knowledge base.
(2) A rule engine or semantic reasoner, which infers information or takes action based on the interaction of input and the rule base.
(3) Temporary working memory.
(4) A user interface or other connection to the outside world through which input and output signals are received and sent.

An expert system is software that attempts to reproduce the performance of one or more human experts, most commonly in a specific problem domain, and is a traditional application and/or subfield of artificial intelligence. A wide variety of methods can be used to simulate the performance of the expert however common to most or all are 1) the creation of a so-called “knowledgebase” which uses some knowledge representation formalism to capture the Subject Matter Experts (SME) knowledge and 2) a process of gathering that knowledge from the SME and codifying it according to the formalism, which is called knowledge engineering. Expert systems may or may not have learning components but a third common element is that once the system is developed it is proven by being placed in the same real world problem solving situation as the human SME, typically as an aid to human workers or a supplement to some information system.

There are two main methods of reasoning when using inference rules: backward chaining and forward chaining.

Forward chaining starts with the data available and uses the inference rules to conclude more data until a desired goal is reached. An rule engine using forward chaining searches the inference rules until it finds one in which the if clause is known to be true. It then concludes the then clause and adds this information to its data. It would continue to do this until a goal is reached. Because the data available determines which inference rules are used, this method is also called data driven.

Backward chaining starts with a list of goals and works backwards to see if there is data which will allow it to conclude any of these goals. A rule engine using backward chaining would search the inference rules until it finds one which has a then clause that matches a desired goal. If the if clause of that inference rule is not known to be true, then it is added to the list of goals. For example, suppose a rule base contains—If Fritz is green then Fritz is a frog. Or If Fritz is a frog then Fritz hops.

Suppose a goal is to conclude that Fritz hops. The rule base would be searched and rule (2) would be selected because its conclusion (the then clause) matches the goal. It is not known that Fritz is a frog, so this “if” statement is added to the goal list. The rule base is again searched and this time rule (1) is selected because its then clause matches the new goal just added to the list. This time, if clause (Fritz is green) is known to be true and the goal that Fritz hops is concluded. Because the list of goals determines which rules are selected and used, this method is called goal driven.

Expert System Architecture

The following general points about expert systems and their architecture have been illustrated.
1. The sequence of steps taken to reach a conclusion is dynamically synthesized with each new case. It is not explicitly programmed when the system is built.
2. Expert systems can process multiple values for any problem parameter. This permits more than one line of reasoning to be pursued and the results of incomplete (not fully determined) reasoning to be presented.
3. Problem solving is accomplished by applying specific knowledge rather than specific technique. This is a key idea in expert systems technology. It reflects the belief that human experts do not process their knowledge differently from others, but they do possess different knowledge. With this philosophy, when one finds that their expert system does not produce the desired results, work begins to expand the knowledge base, not to re-program the procedures.

There are various expert systems in which a rule base and a rule engine cooperate to simulate the reasoning process that a human expert pursues in analyzing a problem and arriving at a conclusion. In these systems, in order to simulate the human reasoning process, a vast amount of knowledge needed to be stored in the knowledge base. Generally, the knowledge base of such an expert system consisted of a relatively large number of “if then” type of statements that were interrelated in a manner that, in theory at least, resembled the sequence of mental steps that were involved in the human reasoning process.

A Subject Matter Expert (SME) is a person who is an expert in a particular area. In software engineering environments, the term is used to describe professionals with expertise in the field of application but without technical project knowledge. SMEs is often asked to review, improve and approve technical work, to guide others, and to teach.

In computer science, and specifically the branches of knowledge engineering and artificial intelligence, a rule engine is a computer program that tries to derive answers from a knowledge base or a rule base. It is the “brain” that expert systems use to reason about the information in the knowledge base for the ultimate purpose of formulating new conclusions. Rule engines are considered to be a special case of reasoning engines, which can use more general methods of reasoning.

The separation of rule engines as a distinct software component stems from the typical production system architecture. This architecture relies on a data store, or working memory, serving as a global database of symbols representing facts or assertions about the problem; on a set of rules which constitute the program, stored in a rule memory of production memory; and on a rule engine, required to execute the rules. (Executing rules is also referred to as firing rules.) The rule engine must determine which rules are relevant to a given data store configuration and choose which one(s) to apply. The control strategy used to select rules is often called conflict resolution.

A rule engine has three main elements. They are:
1. An interpreter: The interpreter executes the chosen agenda items by applying the corresponding base rules.
2. A scheduler: The scheduler maintains control over the agenda by estimating the effects of applying inference rules in light of item priorities or other criteria on the agenda.
3. A consistency enforcer: The consistency enforcer attempts to maintain a consistent representation of the emerging solution.

The recognize-act cycle: The rule engine can be described as a form of finite state machine with a cycle consisting of three action states: match rules, select rules, and execute rules.

In the first state, match rules, the rule engine finds all of the rules that are satisfied by the current contents of the data store. When rules are in the typical condition-action form, this means testing the conditions against the working memory. The rule matching that are found are all candidates for execution: they are collectively referred to as the conflict set. Note that the same rule may appear several times in the conflict set if it matches different subsets of data items. The pair of a rule and a subset of matching data items are called an instantiation of the rule.

The rule engine then passes along the conflict set to the second state, select rules. In this state, the rule engine applies some selection strategy to determine which rules will actually be executed. The selection strategy can be hard-coded into the engine or may be specified as part of the model.

Finally the selected instantiations are passed over to the third state, execute rules. The rule engine executes or fires the selected rules, with the instantiation's data items as parameters. Usually the actions in the right-hand side of a rule change the data store, but they may also trigger further processing outside of the rule engine (interacting with users through a graphical user interface or calling local or remote programs, for instance). Since the data store is usually updated by firing rules, a different set of rules will match during the next cycle after these actions are performed.

The rule engine then cycles back to the first state and is ready to start over again. This control mechanism is referred to as the recognize-act cycle. The rule engine stops either on a given number of cycles, controlled by the operator, or on a quiescent state of the data store when no rules match the data.

Data-driven computation versus procedural control: The rule engine control is based on the frequent reevaluation of the data store states, not on any static control structure of the program. The computation is often qualified as data-driven or pattern-directed in contrast to the more traditional procedural control. Rules can communicate with one another only by way of the data, whereas in traditional programming languages procedures and functions explicitly call one another. Unlike instructions, rules are not executed sequentially and it is not always possible to determine through inspection of a set of rules which rule will be executed first or cause the rule engine to terminate.

In contrast to a procedural computation, in which knowledge about the problem domain is mixed in with instructions about the flow of control—although object-oriented programming languages mitigate this entanglement—the rule engine model allows a more complete separation of the knowledge (in the rules) from the control (the rule engine).

A production system (or production rule system) is a computer program typically used to provide some form of artificial intelligence, which consists primarily of a set of rules about behavior. These rules, termed productions, are a basic representation found useful in AI planning, expert systems and action selection. A production system provides the mechanism necessary to execute productions in order to achieve some goal for the system.

Productions consist of two parts: a sensory precondition (or “IF” statement) and an action (or “THEN”). If a production's precondition matches the current state of the world, then the production is said to be triggered. If a production's action is executed, it is said to have fired. A production system also contains a database, sometimes called working memory, which maintains data about current state or knowledge, and a rule interpreter. The rule interpreter must provide a mechanism for prioritizing productions when more than one is triggered.

A semantic reasoner, reasoning engine, rules engine, or simply a reasoner, is a piece of software able to infer logical consequences from a set of asserted facts or axioms. The notion of a semantic reasoner generalizes that of a rule engine, by providing a richer set of mechanisms to work with. The inference rules are commonly specified by means of an ontology language, and often a description language. Many reasoners use first-order predicate logic to perform reasoning; inference commonly proceeds by forward chaining and backward chaining.

A domain ontology (or domain-specific ontology) models a specific domain, or part of the world. It represents the particular meanings of terms as they apply to that domain. For example the word card has many different meanings. An ontology about the domain of poker would model the “playing card” meaning of the word, while an ontology about the domain of computer hardware would model the “punch card” and “video card” meanings. An upper ontology (or foundation ontology) is a model of the common objects that are generally applicable across a wide range of domain ontologies. It contains a core glossary in whose terms objects in a set of domains can be described.

A knowledge base (or knowledgebase; abbreviated KB, kb) is a special kind of database for knowledge management, providing the means for the computerized collection, organization, and retrieval of knowledge.

Knowledge bases are categorized into two major types: Machine-readable knowledge bases store knowledge in a computer-readable form, usually for the purpose of having automated deductive reasoning applied to them. They contain a set of data, often in the form of rules that describe the knowledge in a logically consistent manner. An ontology can define the structure of stored data—what types of entities are recorded and what their relationships are. Logical operators, such as And (conjunction), Or (disjunction), material implication and negation may be used to build it up from simpler pieces of information. Consequently, classical deduction can be used to reason about the knowledge in the knowledge base. Some machine-readable knowledge bases are used with artificial intelligence, for example as part of an expert system that focuses on a domain like prescription drugs or customs law. Such knowledge bases are also used by the semantic web.

Human-readable knowledge bases are designed to allow people to retrieve and use the knowledge they contain. They are commonly used to complement a help desk or for sharing information among employees within an organization. They might store troubleshooting information, articles, white papers, user manuals, or answers to frequently asked questions. Typically, a search engine is used to locate information in the system, or users may browse through a classification scheme.

Knowledge representation and knowledge engineering are central to AI research. Many of the problems machines are expected to solve will require extensive knowledge about the world. Among the things that AI needs to represent are: objects, properties, categories and relations between objects; situations, events, states and time; causes and effects; knowledge about knowledge (what we know about what other people know); and many other, less well researched domains. A complete representation of “what exists” is an ontology, of which the most general are called upper ontologies.

A pattern is a type of theme of recurring events of or objects, sometimes referred to as elements of a set. These elements repeat in a predictable manner. It can be a template or model which can be used to generate things or parts of a thing, especially if the things that are created have enough in common for the underlying pattern to be inferred, in which case the things are said to exhibit the unique pattern. Pattern matching is the act of checking for the presence of the constituents of a pattern, whereas the detecting for underlying patterns is referred to as pattern recognition. The question of how a pattern emerges is accomplished through the work of the scientific field of pattern formation. Patterns are also related to repeated shapes or objects, sometimes referred to as elements of the series. Some patterns (for example, many visual patterns) may be directly observable, such as simple decorative patterns (stripes, zigzags, and polka-dots). Others can be more complicated, such as the regular tiling of a plane, echos, and balanced binary branching e.g. e.g. Architectural Pattern, Design patterns, Pattern matching, Regular expression.

Working memory (also referred to as short-term memory, depending on the specific theory) is a theoretical construct within cognitive psychology that refers to the structures and processes used for temporarily storing and manipulating information.

The user interface (also known as Human Computer Interface or Man-Machine Interface (MMI)) is the aggregate of means by which people—the users—interact with the system—a particular machine, device, computer program or other complex tool. The user interface provides means of: Input, allowing the users to manipulate a system and Output, allowing the system to indicate the effects of the users' manipulation.

Semantic matching is a technique used in computer science to identify information which is semantically related. Given any two graph-like structures, e.g. classifications, taxonomies database or XML schemas and ontologies, matching is an operator which identifies those nodes in the two structures which semantically correspond to one another. For example, applied to file systems it can identify that a folder labeled “car” is semantically equivalent to another folder “automobile” because they are synonyms in English.

One or more embodiments described herein provide that methods, techniques, and actions performed by a computing device are performed programmatically, or as a computer-implemented method. Programmatically, as used herein, means through the use of code or computer-executable instructions. These instructions can be stored in one or more memory resources of the computing device. A programmatically performed step may or may not be automatic.

One or more embodiments described herein can be implemented using programmatic modules, engines, or components. A programmatic module, engine, or component can include a program, a sub-routine, a portion of a program, or a software component or a hardware component capable of performing one or more stated tasks or functions. As used herein, a module or component can exist on a hardware component independently of other modules or components. Alternatively, a module or component can be a shared element or process of other modules, programs or machines.

Some embodiments described herein can generally require the use of computing devices, including processing and memory resources. For example, one or more embodiments described herein may be implemented, in whole or in part, on computing devices such as servers, desktop computers, cellular or smartphones, personal digital assistants (e.g., PDAs), laptop computers, printers, digital picture frames, network equipments (e.g., routers) and tablet devices. Memory, processing, and network resources may all be used in connection with the establishment, use, or performance of any embodiment described herein (including with the performance of any method or with the implementation of any system).

Furthermore, one or more embodiments described herein may be implemented through the use of instructions that are executable by one or more processors. These instructions may be carried on a computer-readable medium. Machines shown or described with figures below provide examples of processing resources and computer-readable mediums on which instructions for implementing embodiments of the invention can be carried and/or executed. In particular, the numerous machines shown with embodiments of the invention include processor(s) and various forms of memory for holding data and instructions. Examples of computer-readable mediums include permanent memory storage devices, such as hard drives on personal computers or servers. Other examples of computer storage mediums include portable storage units, such as CD or DVD units, flash memory (such as carried on smartphones, multifunctional devices or tablets), and magnetic memory. Computers, terminals, network enabled devices (e.g., mobile devices, such as cell phones) are all examples of machines and devices that utilize processors, memory, and instructions stored on computer-readable mediums. Additionally, embodiments may be implemented in the form of computer-programs, or a computer usable carrier medium capable of carrying such a program.

The many features and advantages of the invention are apparent from the detailed specification and, thus, it is intended by the appended claims to cover all such features and advantages of the invention that fall within the true spirit and scope of the invention. Further, since numerous modifications and changes will readily occur to those skilled in the art, it is not desired to limit the invention to the exact construction and operation illustrated and described, and accordingly all suitable modifications and equivalents may be resorted to, falling within the scope of the invention.

### BRIEF DESCRIPTION OF THE DRAWINGS

Non-limiting and non-exhaustive embodiments of the present invention are described with reference to the following drawings. In the drawings, like reference numerals refer to like parts throughout the various figures unless otherwise specified.

For a better understanding of the present invention, reference will be made to the following Detailed Description, which is to be read in association with the accompanying drawings, wherein:

FIG. 1 is an illustration of an example embodiment or system for enabling a contextual user to user sharing, viewing, auto following to contextual users based on user data & rules for receiving contextual contents, auto contextual followers based on user data & rules for posting or broadcasting or sharing contextual contents, communication, collaboration, participation, conducting one or more activities, actions, events, and transactions, providing or consuming user services;

FIG. 2-4 is an illustration of an example embodiment graphical user interface for one or more types of user profiles, forms for enabling user to provide various types of user details;

FIG. 5 is an illustration of an example embodiment to show exemplary data structure or data tables, rows & columns to show some of the examples of storing of user profile and matching & storing auto identified or determined followers, following users, viewers, connections, contacts & relationships and contextual one or more types of users details;

FIG. 6 is an illustration of examples;

FIG. 7 is an illustration of an example embodiment graphical user interface for posting one or more types of content item(s) to determined or identified followers, viewers, selective, auto matched, and target criteria specific contextual users of network;

FIG. 8 is an illustration of an example embodiment graphical user interface for receiving contents from following users or server determined or identified one or more types of other contextual user(s) of network;

FIG. 9 is a flow chart of example method of identifying contextual followers, following users, viewers, users and connections for user;

FIG. 10 is a block diagram that illustrates a mobile computing device upon which embodiments described herein may be implemented;

While the invention is described herein by way of example for several embodiments and illustrative drawings, those skilled in the art will recognize that the invention is not limited to the embodiments or drawings described. It should be understood, that the drawings and detailed description thereto are not intended to limit the invention to the particular form disclosed, but on the contrary, the intention is to cover all modifications, equivalents and alternatives falling within the spirit and scope of the present invention. The headings used herein are for organizational purposes only and are not meant to be used to limit the scope of the description. As used throughout this application, the word “may” is used in a permissive sense (e.g., meaning having the potential to), rather than the mandatory sense (e.g., meaning must). Similarly, the words “include”, “including”, and “includes” mean including, but not limited to.

### DETAILED DESCRIPTION OF THE DRAWINGS

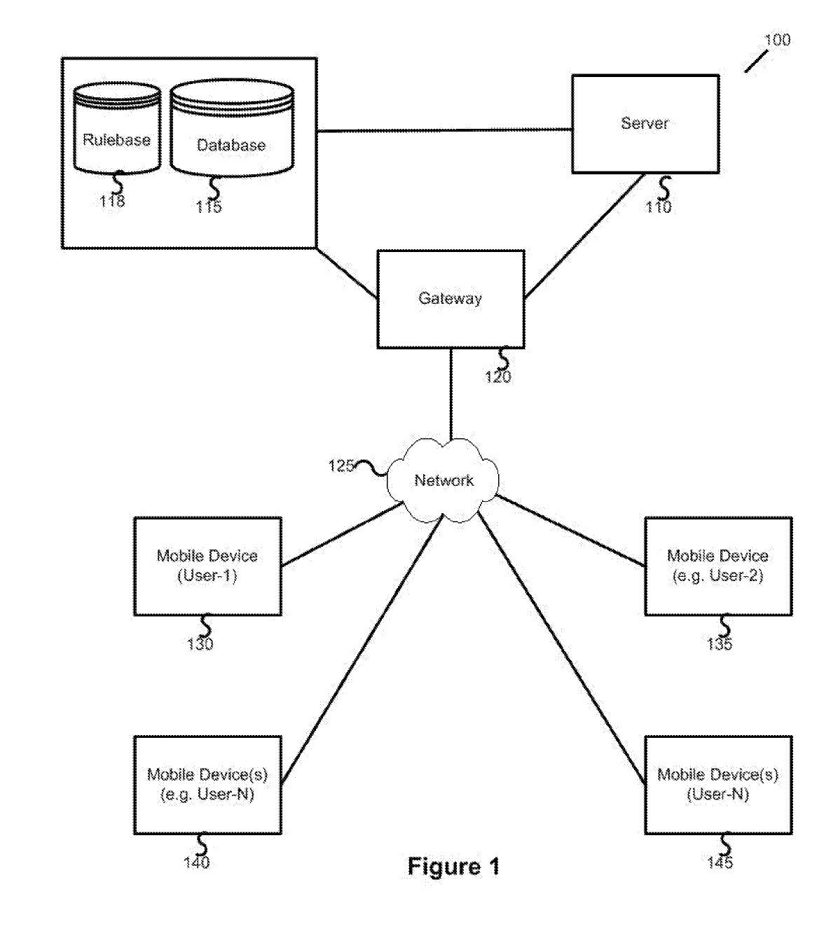

FIG. 1 illustrates an example embodiment electronic device 100 configured to execute example methods of receiving and storing user data, identifying, determining and storing following users, followers, viewers, contacts or connections and one or more types of contextual users based on said user data and identified user related data and based on said user related data identify, apply and execute one or more rules via rule base system to identify contextual one or more types of one or more following users, followers, viewers, contacts or connections and contextual users for enabling sharing, broadcasting, posting, presenting, receiving one or more types of contents, communication, collaboration, sharing, providing or consuming user services, conducting one or more types of one or more activities and participating with them. According to some embodiments, system 100 can be implemented through software that operates on a portable computing device, such as a mobile computing device. System 100 can be configured to communicate with one or more network services, databases, objects that coordinate, orchestrate or otherwise provide advertised contents of each user to other users of network. Additionally, the mobile computing device can integrate third-party services which enable further functionality through system 100.

The system 100 for enabling users to use communication platform for broadcasting or sharing or posting or presenting or advertising user contents to other contextual users or target viewers of network based on one or more server identified or determined and stored followers, viewers, one or more types of connections and contextual users, and user preferences and view contextual contents from following users or other contextual users of network. While FIG. 1 illustrates a gateway 120, a database 115 and a server 110 as separate entities, the illustration is provided for example purposes only and is not meant to limit the configuration of the user to user communication system. In some embodiments, gateway 120, database 115 and server 110 may be implemented in the user to user communication system as separate systems, a single system, or any combination of systems.

As illustrated in FIG. 1, the user to user communication system may include a communication initiator or a posting user device or mobile devices 130/140 and recipient user or viewing user or participant user device or mobile devices 135/ 145. Devices or Mobile devices 130/140/135/145 may be particular set number of or an arbitrary number of devices or mobile devices which may be capable of posting, sharing, publishing, broadcasting, advertising, communicating, sending, presenting, searching, matching, accessing and managing contents. Each device or mobile device in the set of posting or communicating user(s) 130/140 and viewing or participating user(s) device or mobile devices 135/140 may be configured to communicate, via a wireless connection, with each one of the other mobile devices 130/140/135/145. Each one of the mobile devices 130/140/135/145 may also be configured to communicate, via a wireless connection, to a network 125, as illustrated in FIG. 1. The wireless connections of mobile devices 130/140/135/145 may be implemented within a wireless network such as a Bluetooth network or a wireless LAN.

As illustrated in FIG. 1, the user to user communication system may include gateway 120. Gateway 120 may be a web gateway which may be configured to communicate with other entities of the user to user communication system via wired and/or wireless network connections. As illustrated in FIG. 1, gateway 120 may communicate with mobile devices 130/140/135/145 via network 125. In various embodiments, gateway 120 may be connected to network 125 via a wired and/or wireless network connection. As illustrated in FIG. 1, gateway 120 may be connected to database 115 and server 110 of user to user communication system. In various embodiments, gateway 120 may be connected to database 115 and/or server 110 via a wired or a wireless network connection.

Gateway 120 may be configured to send and receive user contents or posts or data to targeted or prospective, matched & contextual viewers and followers based on user data and identified rules, wherein user data comprises user profile, user connections, connected users' data, user shared data or contents, user logs, activities, actions, events, senses, transactions, status, updates, presence information, locations, check-in places, user provided structured or unstructured information via one or more types of profiles, forms, templates and wizards to/from mobile devices 130/140/135/145. For example, gateway 120 may be configured to receive posted contents provided by posting users or publishers or content providers to database 115 for storage.

As another example, gateway 120 may be configured to send or present posted contents to identified contextual viewers and followers stored in database 115 to mobile devices 130/140/135/145. Gateway 120 may be configured to receive search requests from mobile devices 130/140/135/145 for searching and presenting posted contents and users of network.

For example, gateway 120 may receive a request from a mobile device and may query database 115 with the request for searching and matching request specific matched posted contents, sources, followers, following users, connections, one or more types of contextual users and viewers. Gateway 120 may be configured to inform server 110 of updated data. For example, gateway 120 may be configured to notify server 110 when a new post has been received from a mobile device or device of posting or publishing or communicator or content broadcaster(s) or provider(s) stored on database 115.

As illustrated in FIG. 1, the user to user communication system may include a database, such as database 115. Database 115 may be connected to gateway 120 and server 110 via wired and/or wireless connections. Database 115 may be configured to store a database of registered user's profile, accounts, posted or shared contents, followers, following users, connections, one or more types of matched users, followed updated keyword(s), key phrase(s), named entities, nodes, ontology, semantic syntax, categories & taxonomies, user data, payments information received from mobile devices 130/140/135/145 via network 125 and gateway 120.

Database 115 may also be configured to receive and service requests from gateway 120. For example, database 115 may receive, via gateway 120, a request from a mobile device and may service the request by providing, to gateway 120, user profile, user data, posted or shared contents, user followers, following users, viewers, contacts or connections, user or provider account's related data which meet the criteria specified in the request. Database 115 may be configured to communicate with server 110.

As illustrated in FIG. 1, the user to user content advertising system may include a server, such as server 110. Server may be connected to database 115 and gateway 120 via wired and/or wireless connections. As described above, server 110 may be notified, by gateway 120, of new or updated user profile, user data, user posted or shared contents, user followed updated keyword(s), key phrase(s), named entities, nodes, ontology, semantic syntax, categories & taxonomies & various types of status stored in database 115.

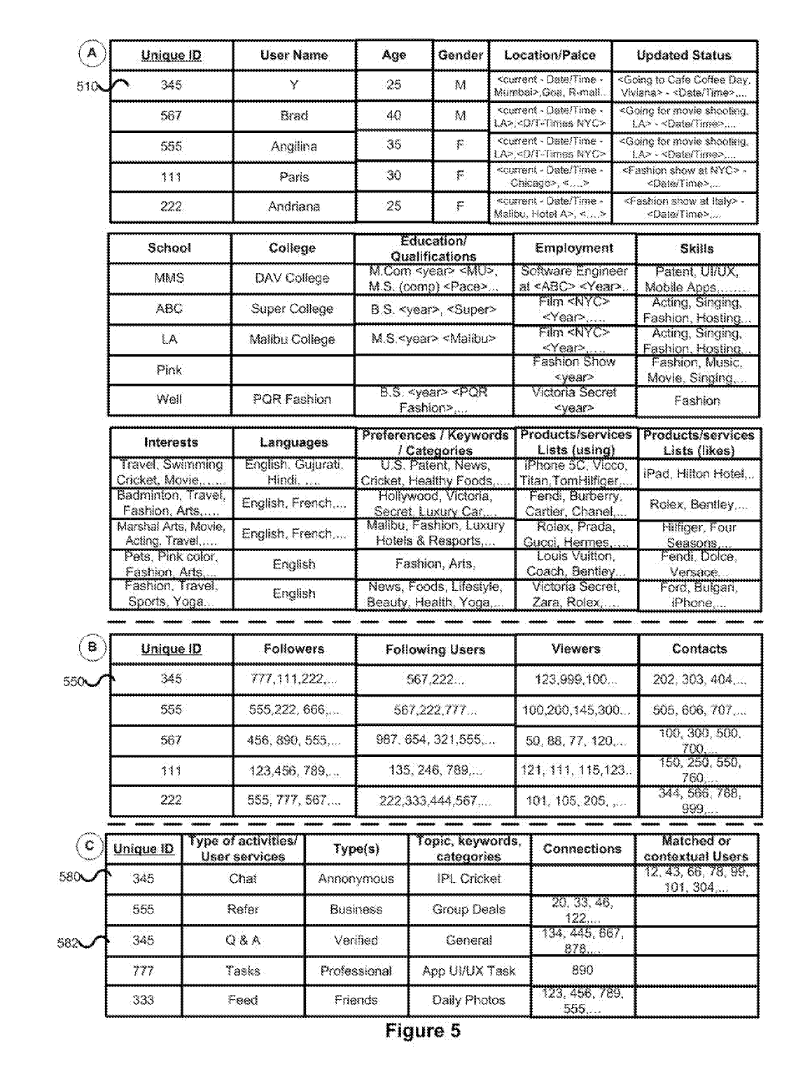

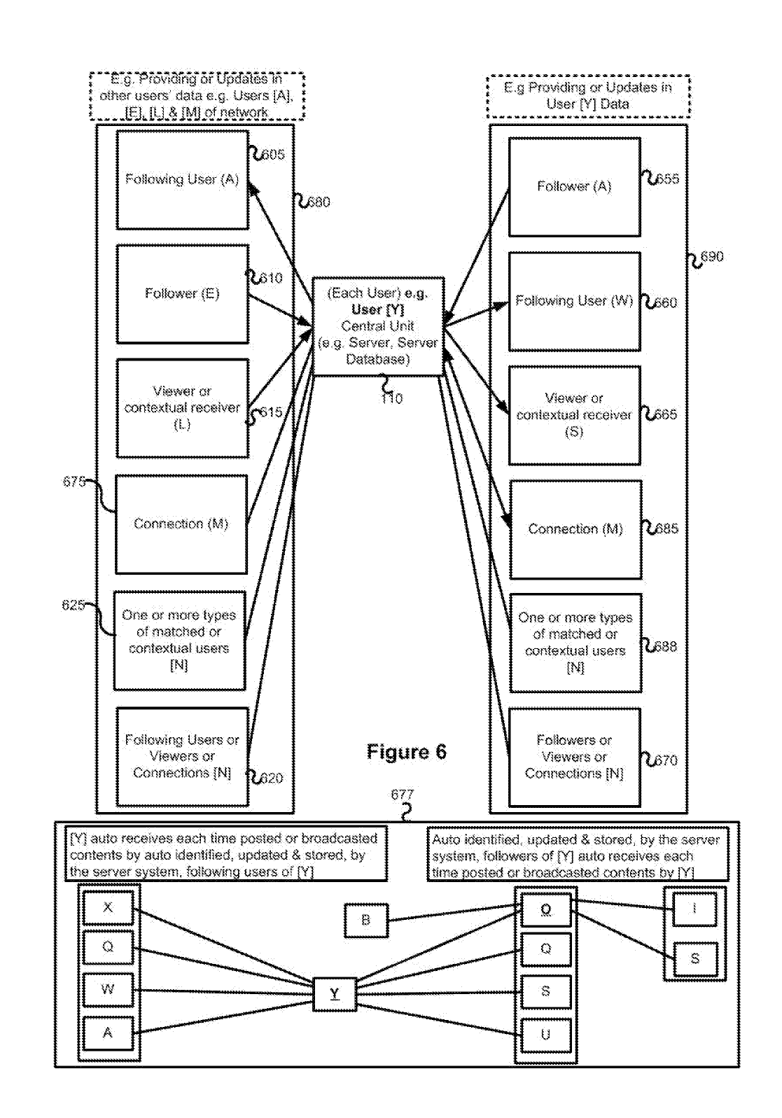

In another embodiment the system for presenting & broadcasting users generated contents to server identified or determined contextual followers, matched one or more types of users and viewers based on user data and identified rules (discussed in detail in FIGS. 5-6) may be referred to herein, for simplicity, as the “user to user communication system” FIG. 1 illustrates a block diagram of user to user communication system configured to implement the platform where user(s) can post contents which lacks intended recipients, wherein server identifies, determines, searches, matches, rank and store recipients including followers, viewers, matched one or more types of users and connections for each user based on user data and identified rules. While FIG. 1 illustrates a gateway 120, a database 115 and a server 110 as separate entities, the illustration is provided for example purposes only and is not meant to limit the configuration of the user to user communication system. In some embodiments, gateway 120, database 115 and server 110 may be implemented in the user to user communication system as separate systems, a single system, or any combination of systems.

As illustrated in FIG. 1, the user to user communication system may include a communication initiator or a posting or broadcasting user device or mobile devices 130/140 and participating user device or viewing user device e.g. mobile devices 135/145. Devices or Mobile devices 130/140/135/145 may be particular set number of or an arbitrary number of devices or mobile devices which may be capable of posting, sharing, publishing, broadcasting, communicating, advertising, sending, presenting, searching, accessing and managing shared contents to target contextual viewers or followers or one or more types of matched users of network. Each device or mobile device in the set of communication initiator(s) or posting user(s) 130/140 and viewing user(s) or participating user(s) device or mobile devices 135/140 may be configured to communicate, via a wireless connection, with each one of the other mobile devices 130/140/135/145. Each one of the mobile devices 130/140/135/145 may also be configured to communicate, via a wireless connection, to a network 125, as illustrated in FIG. 1. The wireless connections of mobile devices 130/140/135/145 may be implemented within a wireless network such as a Bluetooth network or a wireless LAN.

As illustrated in FIG. 1, the user to user communication system may include gateway 120. Gateway 120 may be a web gateway which may be configured to communicate with other entities of the user to user communication system via wired and/or wireless network connections. As illustrated in FIG. 1, gateway 120 may communicate with mobile devices 130/140/135/145 via network 125. In various embodiments, gateway 120 may be connected to network 125 via a wired and/or wireless network connection. As illustrated in FIG. 1, gateway 120 may be connected to database 115 and server 110 of the user to user communication system. In various embodiments, gateway 120 may be connected to database 115 and/or server 110 via a wired or a wireless network connection.

Gateway 120 may be configured to send and receive user posted contents or posts or data to prospective, server identified & determined, matched & contextual followers and viewers based on user data of users and identified executed rules via rule base system, wherein user data comprises user profile, user connections, connected users' data, user shared data or contents, user logs, activities, actions, events, senses, transactions, status, updates, presence information, locations, check-in places and like to/from mobile devices 130/140/135/145. For example, gateway 120 may be configured to receive posted contents provided by posting users or publishers or content broadcasters to database 115 for storage.

As another example, gateway 120 may be configured to send or present posted contents to followers, connections, contextual users and viewers stored in database 115 to mobile devices 130/140/135/145. Gateway 120 may be configured to receive search requests from mobile devices 130/140/135/145 for searching and presenting posted contents.

For example, gateway 120 may receive a request from a mobile device and may query database 115 with the request for searching and matching request specific matched posted contents, sources, followers, following users and viewers who are located at request specific place(s) or location(s). Gateway 120 may be configured to inform server 110 of updated data. For example, gateway 120 may be configured to notify server 110 when a new posts has been received from a mobile device or device of posting or publishing or content broadcaster(s) provider(s) stored on database 115.

As illustrated in FIG. 1, the user to user communication system may include a database, such as database 115. Database 115 may be connected to gateway 120 and server 110 via wired and/or wireless connections. Database 115 may be configured to store a database of registered user's profile, accounts, posted or shared contents, followed updated categories & taxonomies, user data, payments information received from mobile devices 130/140/135/145 via network 125 and gateway 120.

Database 115 may also be configured to receive and service requests from gateway 120. For example, database 115 may receive, via gateway 120, a request from a mobile device and may service the request by providing, to gateway 120, user profile, user data, posted or shared contents, user or provider account's related data which meet the criteria specified in the request. Database 115 may be configured to communicate with server 110.

As illustrated in FIG. 1, the user to user communication system may include a server, such as server 110. Server may be connected to database 115 and gateway 120 via wired and/or wireless connections. As described above, server 110 may be notified, by gateway 120, of new or updated user profile, user data, user posted or shared contents, user followed updated categories & taxonomies & various types of status stored in database 115.

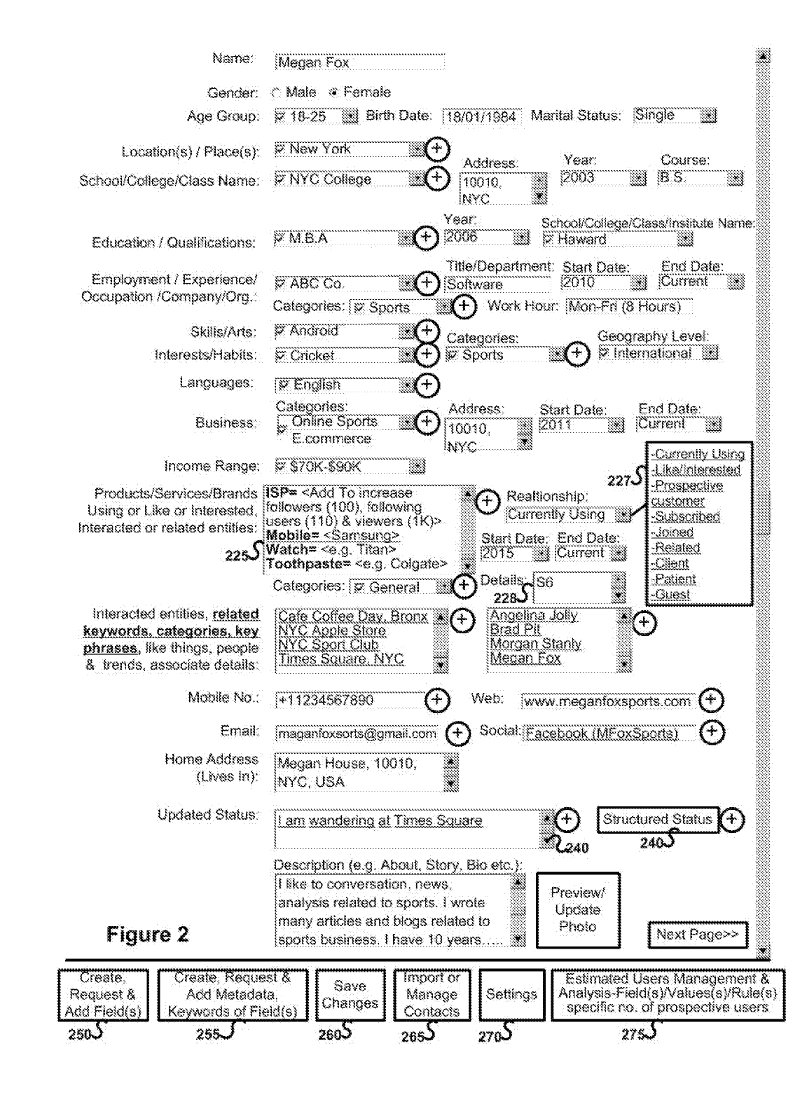

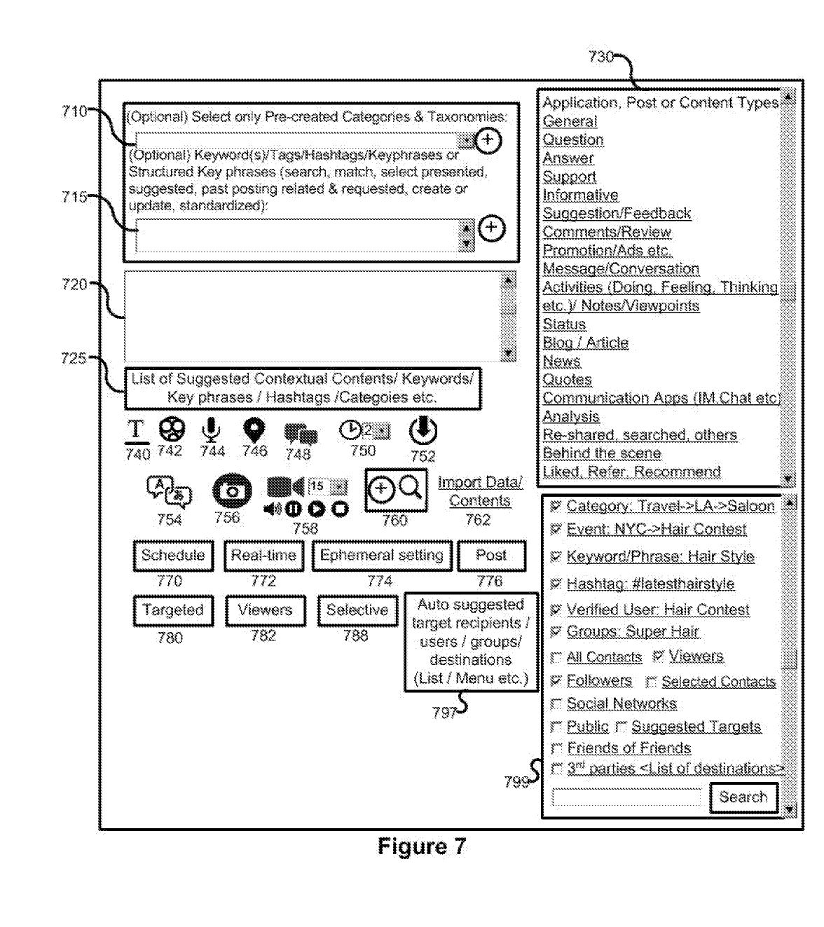

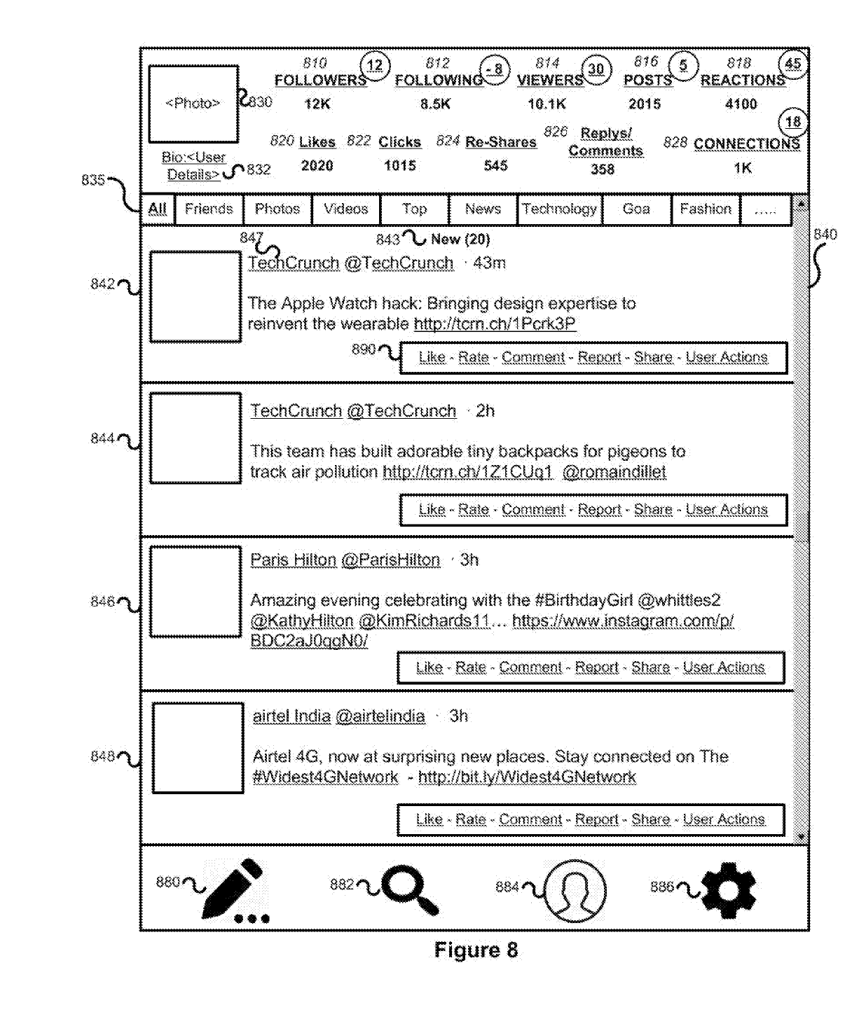

As illustrated in FIG. 1, the user to user communication system i.e. a computer-implemented method for facilitating user-to-user communication in a network environment, the method comprising: receiving, by a server system 110 from first computing devices 130 on behalf of a plurality of users 140 or 145 in the network 125 environment, herein called “viewing users” e.g. 130, a corresponding plurality types of user data; storing, by a server system each user related user data in a storage 115 (discuss in detail in FIGS. 2-4); identifying, by a server system 110 each user specific list of followers, following users, viewers and one or more types of contextual or matched users or sources (discuss in detail in FIGS. 5-6) based on user data 115 and/or identified, associated, applied and executed one or more rules 118 via rule base system, ontology, semantic syntax, semantic matching, contextual users or sources from pre-created categories of sources or users, user followed or subscribed or likes or requested sources, and user contacts or connections; storing, by a server system in a storage 115 each user specific said list of followers, following users, viewers and one or more types of contextual or matched users or sources (discuss in detail in FIGS. 5-6); receiving, by the server system from a second computing device e.g. 135 on behalf of a user e.g. 135 in the network 125 environment, herein called the “broadcasting user” e.g. 135, a broadcast request or posting request to broadcast or post 776 a specific item(s) of content 720 (discuss in detail in FIG. 7), wherein the broadcast or posting request lacks identification of an intended recipient, and wherein the broadcast or posting request includes an identification of the broadcasting or posting user e.g. 135; and determining or identifying, by the server system 110, in response to the broadcast request 776, based on identified or determined one or more intended recipients (discuss in detail in FIGS. 5) as applied to the broadcast request, any viewing users then eligible to receive the specific item of content(s) 840 (discuss in detail in FIG. 8).

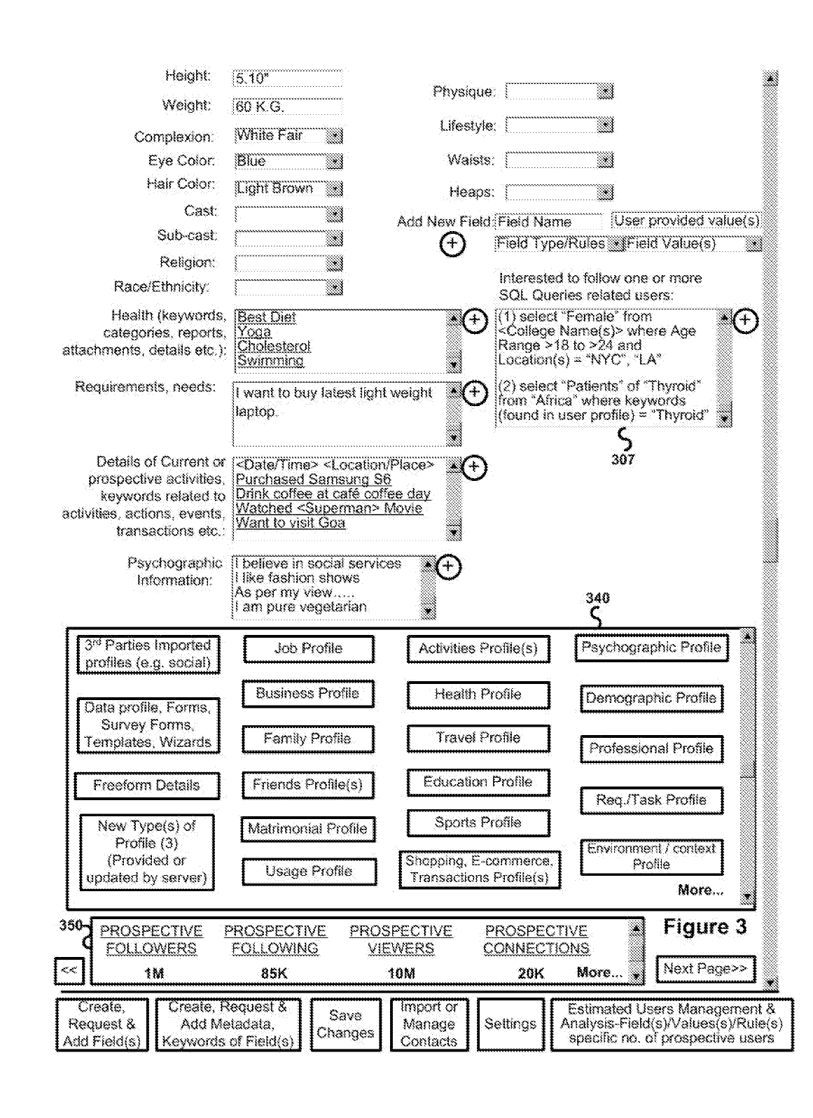

FIG. 2-3 is an illustrated of an example embodiment graphical user interface enabling user to provide plurality types of user data via presented forms, updated forms, user created or updated customized forms and fields, various types of user profile interfaces, templates, categories survey forms, application(s), wherein user data comprise user profile or user details provided by user, connected or related users of user, 3^{rd} parties web sites, applications, service providers, experts, servers, databases, devices & networks, identified by server 110 including user name, photo, video, voice, various addresses, contacts & social information, age, gender, marital status, interest, school, college, employer, company, skills, languages, education, qualifications, income range, habits, religion, height, weight, cast & like, user activities, actions, events, transactions, senses, interactions, behavior, interacted entities, locations, places, contacts or connections, presence information, updated free form status 240, updated structured status 240, wherein enabling user to select or provide parts of structured status 240, including select types of activities, purposes, status, actors, roles, actions, profile properties or fields and/or associate values, events & transactions, select location, place, nodes, product, service, items, grammar syntax, contact or connection or user name, rules, keywords, key phrases, objects, conditions, and one or more types of entities to form or create or draft structured status, key phrases, keywords, categories, preferences, shared contents, viewed contents, subscribed contents, filled domain or subject or requirement or activities specific forms, one or more types of lists including products and services using or like to use and privacy settings.

FIG. 2-3 is an illustrated of an example embodiment graphical user interface(s), wherein interface(s) e.g. 340 comprise one or more forms, pages of forms, applications, web pages, web sites, customized forms or interface, editors, one or more types of controls or objects or functions including presented or contextual or dynamic or customized textbox, check boxes, radio buttons, combo boxes, auto fill, auto suggested lists, auto completion, auto identified and/or fill data, tabs, menus, list boxes, wizards, slider, tables, grids, toolbars & buttons, enabling user to provide various types of user details via selecting, inputting & editing one or more values for one or more fields or sub-fields or field or value of field associate type of metadata. User can provide details of one or more types of one or more interacted entities 225, categories of entity, associate relationships 227 and structured or unstructured details 228, associate estimated number of contextual users who are prospective to become user followers, following users, viewers & connections. User can search or user is presented with various categories or types specific entities, products, services, items, objects, nodes, people, brands, company, school, college, activities, actions, events, & transactions, so user can select said one or more entity or item type and can provide one or more associate values.

In another embodiment user can add or create or update one or more fields and sub-fields 250 including field name, field data type, constraints or rules & associate default values, one or more values of one or more fields 255, metadata and request server to verify, validate, rank & add or store them for making them available for other users of network. So they can provide one or more fields specific user derails and values.

In another embodiment user is presented with server created or updated or user enabled to dynamically create or update customized one or more types of forms or interfaces or applications for providing various types of user related or provided details.

In another embodiment user is enabled to view one or more or group(s) of fields and or field(s) associate one or more value(s) specific or any combination thereof associate estimated total or user related number of prospective 275 and 350 followers, following users, viewers, one or more types or categories specific contextual or matched users and connections.

In another embodiment user is enabled to imports contacts from user's phone book(s), social contacts, email contacts and one or more types of contacts or connections from one or more sources, applications, services, web sites, devices, servers, databases & networks via one or more types of communication interfaces, web services and Application Programming Interface (API).

In another embodiment alerting or notifying or instructing user within interval or after particular period of time to provide one or more types of or field(s) specific details or one or more types of media items inkling text, link, photo, video, voice, files or attachments, location information via one or more types of interfaces, applications, web pages, forms, wizards, lists, templates and controls. In another embodiment making compulsory to provide or update one or more types of user data or provide or update one or more types of user data within particular period of time to accessing system.

In another embodiment user is enable to provide or set or apply one or more types of settings including opt-in for one or more types for notifications, provide payment details, update accounts including provide or verify mobile phone number, email address, apply security and change password, presentation settings, privacy settings, and preferences.

In another embodiment user can provide one or more Structured Query Language (SQL) queries 307 to enable server system 110 and database 115 to process, search, match, select and store said one or more SQL queries specific followers, following users, viewers, contacts or connections and one or more types of or categories of contextual or matched users. In an embodiment user is enable to draft or create or update or validate SQL queries based on user friendly graphical interface (GUI) or wizard or forms or step by step walkthrough via selecting or auto fill parts or syntax of queries including syntax, condition types, data fields, & values.

In another embodiment user is enable to provide one or more types of one or field specific details by selecting via auto fills or auto completion.

In another embodiment enable enterprise users including brands, products, service providers, sellers, manufacturers, companies, shops, people, colleges, organizations, companies and one or more types of entities to verify account, provide or update details and provide required one or more types of target audience including followers and viewers, wherein target criteria comprise include or exclude one or more locations & places including countries, cities, tows, address, zip code, longitude & latitude, number of followers and/or viewers and/or connections and/or contextual users and/or actual customers and/or prospective customers and/or types of user actions, age ranges, interests, actual and/or prospective customers or clients or guests or buyers, subscribers, users, viewers or listeners or application users, gender, one or more named entities, networks, groups, languages, education, skills, income ranges, type of activities, actions, events, transactions & status, and one or more types of user data or user profile related fields and values. In another embodiment enterprise users charge for per auto identified, determined and/or stored followers, viewers, connections, contextual users and type of user actions including buy, appointment, order, group deal, fill form, register & download. In another embodiment enterprise users charge for auto identified, determined and/or stored followers, viewers, connections, contextual users, number of posts and type of user actions including buy, appointment, order, group deal, fill form, register & download within particular period of time e.g. hourly, daily, monthly, quarterly and yearly. In another embodiment identified enterprise users from current user accounts based on user data and invite them to convert to paid enterprise user. In another embodiment in the event of not converting to enterprise accounts block or remove or send notification them to convert to paid account. In another embodiment enable enterprise users to search, match, browse users directories & categories lists and allow manually selecting and following users and/or group of users and/or categories or lists of users. In another embodiment enable enterprise users to un-follow any followed users or restrict one or more types of or selected users to viewers their feeds or posts.

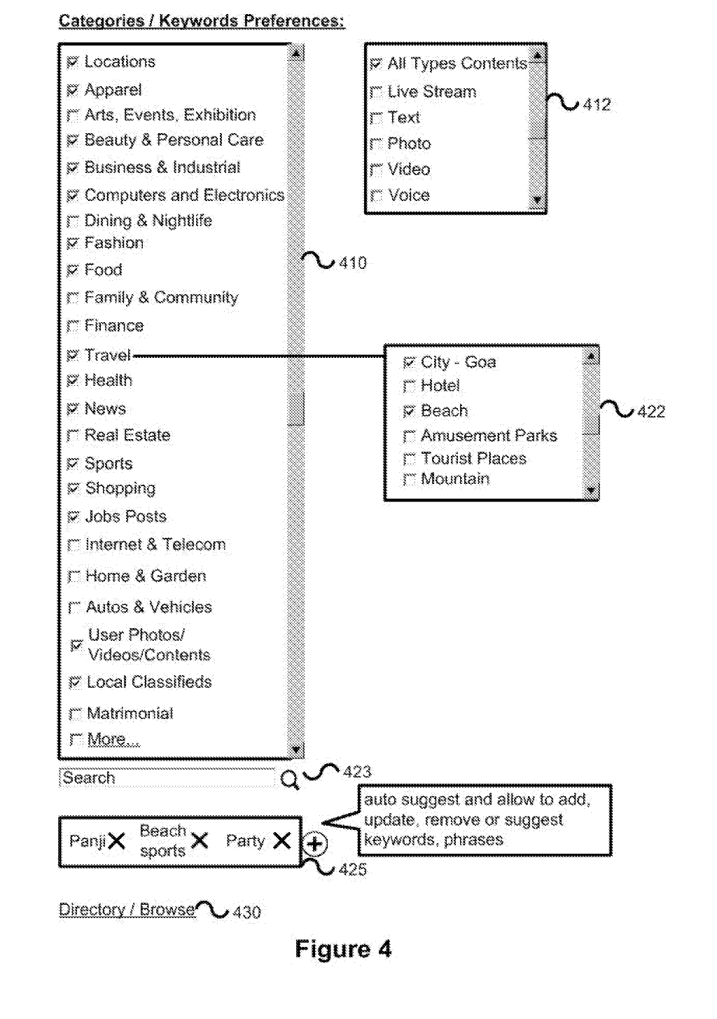

FIG. 4 is an illustrated of an example embodiment graphical user interface enabling user to search 423, match, browse 430, select from suggested list(s) and select or provide preferences 410 including one or more categories and sub-categories, taxonomy and ontology 422, keywords, key phrases 425 and type(s) of media or contents 412 for enabling server system to identify followers, following users, viewers, one or more type or category specific contextual or matched users and connections based on said user preferences.

FIG. 5 is an illustrated of an exemplary data structure showing that server system receives and stores (FIG. 4 (A)) from user devices on behalf of a plurality of users in the network environment, herein called “viewing users”, a corresponding plurality types of user data. After storing various types of user data discuss in detail in FIG. 2-4, server system enabled to identify or determine and stores each user specific other users of network (FIG. 4 (B)) including followers, following users, viewers, group members, connections, contacts, domain or subject specific contextual users, participants for conducting one or more types of communications, collaborations, sharing, activities, actions, events, tasks & transactions (FIG. 4 (C)), provider or consumer of user services based on user data and/or identified, associated, applied and executed one or more rules via rule base system, ontology, semantic syntax, semantic matching, contextual users or sources from pre-created categories of sources or users, user followed or subscribed or likes or requested sources, and user contacts or connections.

In an embodiment server system 110 identifies or determines or matches each user specific other users of network based on user data, wherein user data comprise user profile including age, gender, interest, school, college, employer, company, skills, languages, education, qualifications, income range, habits, religion, height, weight, cast & like, user activities, actions, events, transactions, senses, interactions, behavior, interacted entities, locations, places, contacts or connections, status, structured status, key phrases, keywords, categories, preferences, shared contents, viewed contents, subscribed contents, filled domain or subject or requirement or activities specific forms, one or more types of lists including products and services using or like to use and privacy settings.

In an embodiment server system 110 is enabled to update each user's followers, following users, viewers or prospective viewers, prospective connections or contacts and one or more types or categories of matched users FIG. 5 (B) & (C) in the event of one or more updates in one or more users of network's user data FIG. 5 (A) provided by user, contacts or connections of users, 3^{rd} parties, and auto identified by server system, wherein at particular interval of period of time or based on user's current or selected one or more locations, places, activities, actions, events & transactions alerting or notifying or make compulsory for each user to update user profile, requested one or more types of information and user data within particular period of time and in the event of providing of requested user data by user, allowing user to access system.

In an embodiment user and user related server identified or determined contextual or matched one or more types of one or more users including one or more followers, following users, viewers, and connections are enabled to communicate, collaborate, share, conduct or participate with one or more activities, actions, events & transactions and provide or consume services by using one or more types of one or more applications, interfaces, user actions, widgets, set of controls, objects, web sites, web pages and web services or user services including real-time chat, instant messaging, collaboration application, mutual following, and invite to connect FIG. 5 (C).

FIG. 6 is an illustrated of an exemplary logical map shows server system 110 identifies, determines, auto matched, search, match, rank and stores each user of network specific followers, following users, viewers, group members, connections, contacts, domain or subject specific contextual users, participants for conducting one or more types of communications, collaborations, sharing, activities, actions, events, tasks & transactions, provider or consumer of user services based on user data and/or identified, associated, applied and executed one or more rules via rule base system, ontology, semantic syntax, semantic matching, contextual users or sources from pre-created categories of sources or users, user followed or subscribed or likes or requested sources, and user contacts or connections. For example after downloading application to access user to user communication features or various innovative embodiments describe throughout the application, User [Y] can provide mobile number to verify the mobile number. After verification of mobile number via SMS or any other method known in arts and providing of user name and user photo, server system 110 register the user and store said one or more types of user details at database 115. After successful registration user is resented with profile interface or one or more types of forms, customizable forms, interfaces, applications, web pages, web sites, controls, objects, functions, wizards, templates & lists for enabling said e.g. user [Y] to provide various types of details requested by server system 110. At initial level few details ask to user and later or gradually or at particular interval of period of time ask more details from user. After receiving, processing, updating, storing at database 115 and indexing various types of user details from each user, server system 110, identifies and determines one or more rules from rule base 118 via rule base system, based on said user provided or user related data, which can applied to user in identifying, determining and storing at server database 115/FIG. 5 (B) & (C) one or more followers, following users, viewers, group members, connections, contacts, domain or subject specific contextual users, participants for conducting one or more types of communications, collaborations, sharing, activities, actions, events, tasks & transactions, provider or consumer of user services. For example user [Y] provides user data to server system 110 which stores said user data at 115 and based on said user data server identifies one or more rules from rule base 118 related to user [Y] and matching said user [Y]'s related data FIG. 5 (A) with other users of network data and applying said identified one or more rules to search, match, rank, index, identifies, determines, retrieve, update, process and store 550/580/582 said user [Y] 510 related or matched or contextual or identified one or more followers e.g. 655, following users e.g. 660, viewers e.g. 665, group members, connections e.g. 685, contacts, domain or subject specific contextual users e.g. 688, participants for conducting one or more types of communications, collaborations, sharing, activities, actions, events, tasks & transactions, provider or consumer of user services e.g. 688 or 670. When other user's data updates e.g. User [A] 605 or user [E] 610 or user [L] 615 or user [M] 675 or 625 or 620 then based on said user provided data server system 110 identifies and determines one or more rules from rule base 118 via rule base system. Based on said identified and executing rules and matching each user's data with other user(s) provided or user(s) related data of other users of network, server system 110 identifies, determines and stores at server database 115/FIG. 5 (B) & (C) one or more followers e.g. 610, following users e.g. 605, viewers e.g. 615, group members, connections e.g. 675, contacts, domain or subject specific contextual users e.g. 625, participants for conducting one or more types of communications, collaborations, sharing, activities, actions, events, tasks & transactions, provider or consumer of user services e.g. 620 or 620. So after receiving, processing, storing or updating of one or more types of user data from one or more users of network cause server system 110 to identifies and determines one or more rules from rule base 118 via rule base system. Based on said identified and executing of said identified rules and other user provided or user related data of other users of network server system 110 identifies, determines, updates and stores at server database 115/FIG. 5 (B) & (C) one or more followers, following users, viewers, group members, connections, contacts, domain or subject specific contextual users, participants for conducting one or more types of communications, collaborations, sharing, activities, actions, events, tasks & transactions, provider or consumer of user services for each user of network.

In an embodiment 677 shows that user [Y] auto receives each time posted or broadcasted contents by auto identified, updated & stored, by the server system, following users of [Y] and/or auto identified, updated & stored, by the server system, followers of [Y] auto receives each time posted or broadcasted contents by [Y]. User does not have to manually search, match, select, manually tap on “follow” button, send or accept invitation to follow others. The server system 110, auto identified plurality of contextual or matched sources for each user of network and store to server connected database 115. So when each user posts one or more types of one or more content item(s) then server receives unique identification of posting user, wherein post does not require for posting user to select or identify target recipients or post lacks identification of target or intended recipient(s). After receiving post from user the server system 110, search or match or retrieve or identify said posting user's unique identification related stored unique identification of followers or users and present representation of said posted content item to said identified each or one or more or requested or logged-in or online one or more followers.

FIG. 7 is an illustrated of an example embodiment graphical user interface enabling user e.g. user [Y] to post one or more types of media or content item(s) including text & links 740, emoticons 742, voice 746, location information 746, conduct real time chat or instant messaging or one or more types of other applications 748, search or select photo or video or file 760, capture photo 756, record video 758, translated text 754, import structured or unstructured data or contents 762, wherein posting or broadcasting request which lacks identification of an intended recipient(s), wherein server identifies and present content item(s) to intended recipients based on said identified other users of network 115 FIG. 5 (B) & (C) and/or enable user, by the server system to communicate, collaborate, share, connect, conduct one or more types of one or more activities, provide or consume one or more user services and participant with said identified one or more other users of network e.g. 748. User can select one or more categories 710, keywords 715 and types of contents related to posting 720. User can search, match, select and/or edit or update one or more types of one or more content items from suggested list of contents 725, wherein suggested list of content items or one or more types of media item(s) suggested or presented based on user data including one or more types of user profiles, fields and associate values, past or current locations & places, current date & time, status, presence information, connected users' data, keywords related to most liked or ranked or interacted content items by user, contacts, followers & viewers, user data of followers and/or viewers and/or advertised or sponsored or suggested by server system 110 or server database e.g. 115 and/or connections and/or one or more types or categories of contextual users of network and any combination thereof. After drafting or preparing one or more types of media user can save draft 752 or user can post 776 one or more types of content item(s) 720 to database 115 via sever system 110. In an embodiment notifying and alerting user at particular interval of period of time e.g. daily 5 times or after each 2 hours to post one or more types of content item(s). In an embodiment notifying and alerting user to post content item from suggested list of content items, wherein suggested list includes news, trending topics, user specific contextual contents search from internet or provided by 3^{rd} parties or provided by advertisers or sponsors or provided by top ranked users or experts.

In another embodiment user can schedule 770 posting of one or more types of content item(s) 720 to database 115 via sever system 110. User can make post ephemeral as per settings including set particular period of time e.g. 5 seconds to view user's post by recipients and after set particular period of time e.g. 5 seconds remove or hide post from recipient(s) device(s) or application(s) or client application(s) or interface(s).

In another embodiment user is enable to post one or more types of one or more content items e.g. 720 with target criteria 780, so user's post can view by target criteria specific defined or created audience i.e. posting request or broadcast request comprise one or more type of content or media and associate one or more target criteria, wherein matching of content and one or more associated target criteria of posting user with user data of other users of network, posting or communicating target criteria comprise one or more keywords, categories, types, locations, places, age range, gender, entity names & types, interests, languages, include or exclude IP address, destinations & one or more type of criteria and user data comprise user profile, logged activities, actions, events, transactions, locations, places, status, preferences, privacy settings, search query, keywords, past views of contents. In an embodiment posting user is presented with posting user and/or post specific suggested target criteria, so user can view, select, edit and define target criteria.

In another embodiment user is enable to post one or more types of one or more content items e.g. 720 to contextual viewers only 782, wherein server system 110 can determine or identifies viewers for each post based on posting user specific stored viewers e.g. FIG. 5 (B—Viewers column) and dynamically or real-time identifies viewers based on matching keywords of post contents with user data of other users of network, type of content or media, number of online or available viewers, posting user's rank (number of interactions, number of posts, number of likes, comments, re-share, & user actions on post by other users of network).

In another embodiment user is enable to post one or more types of one or more content items e.g. 720 to one or more selective destinations 788 including send to or post to or broadcast to selected contacts, connections, group(s), friends of friends, network(s), categories of user(s), lists, searched or matched user(s), domain(s), user(s) of network, follower(s), following user(s) and viewer(s) or send to all friends, all users of network (Public), let server identifies or determines intended recipients.

In another embodiment user is enable to post one or more types of one or more content items e.g. 720 by calling or alerting or inviting or notifying 772 to one or more contacts and/or connections and/or group(s) and/or follower(s) and/or following use(s) and/or searched or selected or categories of users and in the event of call or alert or invitation or notification accept by callee user(s) then only present said posted content item(s) and/or allow to take one or more user action(s). So posting user's purpose is recipient(s) can real-time view and react on post. So posting user real-time see number of viewers or views, number of one or more types of reactions on post(s) provided real-time by call accepted users or callee(s).

In another embodiment user is enabled to post content item(s) to suggested destinations 797 or select one or more destinations or intended recipients from suggested list of recipients 799 including post under one or more categories, activities, actions, events, contests, user incentive scheme or contest or offers to post content under one or more hash tags related to one or more sponsors or provided by brands, sellers, shops, and advertisers, taxonomies, keywords, key phrases, suggested one or more verified users & users of network, all or selected contacts or connections, all or selected one or more followers and/or viewers and/or groups and/or one or more types of categories of contextual or matched or pre-stored users of network, one or more social networks, post to suggested or edited target criteria specific audience, 3rd parties web sites, applications, user profile, web services, domains, databases, servers, networks, and one or more users or one or more types or categories of users and post to public or search engine for making them available or searchable for all users, wherein in suggestions is/are based on type of content drafted, keywords, key phrases, categories related to content, identify keywords or details based on photo or video content analysis & manipulation, followers, following users, contacts, connections, viewers, most liked users, users who most liked or ranked posting user's posts and one or more types of user data. In an embodiment auto select via selecting check box(es) one or more suggested destinations or recipients where user's posted content item(s) send, upload, broadcast, advertise, publish, share, store and present, wherein auto selection based on keywords of content(s), math making of posting user's location, place, date & time with server stored one or more activities, actions, & events, advertisements related contents, user's liked or best contacts or friends. In an embodiment enable user to un-select checkbox(es) or select more check box(es) or keep as it and post content item(s) to said selected destinations or recipients.

In another embodiment user is enabled to select one or more types of contents 730. In one embodiment based on user selection of type of content or post or application 730 user is presented with one or more applications, forms, structured forms, customizable forms or interfaces, set of controls, objects and functions, widgets, data or content or one or more types of media and any combination thereof.

In an embodiment notify posting user about number of views, likes, comments, ranks and one or more types of interactions with post by receiving or viewing users including user's followers and viewers or contextual receivers.

After receiving, by the server system 110, one or more types of user data or updated user data from users of network (discuss in detail in FIGS. 2-4) at database 115 and storing 115, by the server system 110, identified, determined, searched, matched (discuss in detail in FIGS. 5-6) followers, following users, viewers, group members, connections, contacts, domain or subject specific contextual users, participants for conducting one or more types of communications, collaborations, sharing, activities, actions, events, tasks & transactions, provider or consumer of user services based on user data of user(s) of network and/or identified, associated, applied and executed one or more rules via rule base system, ontology, semantic syntax, semantic matching, contextual users or sources from pre-created categories of sources or users, user followed or subscribed or likes or requested sources, and user contacts or connections. The server system 110 receives from a second computing device on behalf of a user in the network environment, herein called the “broadcasting user”, a broadcast request or posting request to broadcast or post a specific item(s) of content, wherein the broadcast or posting request lacks identification of an intended recipient, and wherein the broadcast or posting request includes an identification of the broadcasting or posting user; and determining or identifying, by the server system, in response to the broadcast request, based on identified or determined one or more intended recipients as applied to the broadcast request, any viewing users then eligible to receive the specific item of content(s).

FIG. 8 is an illustrated of an example embodiment graphical user interface shows that server system 110 presents one or more types of one or more content items or media including text, link, photo, image, video, voice, location information, documents or file, attachment and any combination thereof to intended recipient(s) e.g. FIG. 5 (B) & (c) comprises followers, viewers, contacts identified or determined by the server system or stored by the server system at database(s). Presented one or more types of one or more content items or media including text, link, photo, image, video, voice, location information, documents or file, attachment and any combination thereof to intended recipients comprises followers, viewers, contacts identified or determined or real-time determined by the server system or stored by the server system at database(s).

In an embodiment user can view received contents, from one or more sources including contacts, all followers, category of content or follower(s), type of media specific including photo or video or stream, categories of preferences of contents or sources, server determined categories, in categories by accessing categories tabs 835.

In an embodiment server system 110 continuously or frequently or within particular period of interval updates presented or served new content items from identified or determined one or more following users, sources and contextual users of network 843.

In an embodiment user can view number of followers 810, following users 812, viewers 814, posts 816, connections 828 and reactions 818 including number of likes 820, clicks on links 822, re-shares 824, reply or comments 826, user actions. User can view profile related photo or video or image 830 and short user bio or details 832.

In an embodiment user can search, match, select, mark as read or unread, bookmark, rank, filter, sort one or more presented content items 840. User can take one or more actions on one or more content items 840 or 842, 844, 846, 848 including like, dislike, report, request to block or mute or un-follow, rate, comment, re-share, reply.

In an embodiment user can access content source or content provider profile via clicking on link 847.

In an embodiment user can search 882 content items posted by users of network, user contacts, one or more types of contextual or matched categories of users, followers and following users.

In an embodiment user can draft, edit or prepare 880 and post one or more content items (discuss in detail in FIG. 7) with intention to posted content item seen or viewed by contextual users or viewers of network and user's followers.

In an embodiment user can provide one or more types of user data 884 (discuss in detail in FIG. 2-4)

In an embodiment user is enabling to manage user account(s) and set or apply or select one or more types of preferences, privacy settings, rules and presentation settings 886.

In a various embodiments enable following or un-following, followers and broadcasting or providing or presenting contents based on rules, policies, privacy settings, preferences and server rules & settings, wherein one or more rules including not allowing user to manually un-follow sources, allowing user to manually follow to contacts or connected users only including phone contacts, email addresses via email accounts, and social friends or connections, limit maximum numbers of auto followers based on number of following users and number of followers, limit number of maximum content items received or presented to user from all or each sources within particular period of time based on number of followers of user, daily engagement or number of viewing of content items within particular period of time, bookmarked or liked or ranked sources or sources of liked or ranked contents, user contacts, allow user to set maximum number of content item within particular period of time including (per minute, hour, daily, monthly) or time ranges from all or one or more selected or particular or categories of sources, limit maximum number of posting of content items within particular period of time, limit receiving of maximum number of content items from all or particular or one or more selected sources or category or keyword(s) or field specific sources, allow to un-follow after reaching particular number of following users or sources, fill or provide value(s) of particular number of field(s) of profile in particular interval of period of time, ratio of followers and following, enable user to un-follow one or more sources including enable to un-follow one or more sources by permitted users only, enable to un-follow one or more sources based on maximum limits of particular number of un-following of sources permitted within particular duration, request server to un-follow one or more sources with reason(s), report one or more sources as spam or inappropriate content(s), the server system is enable to auto un-follow user(s) to one or more followed sources based on updated user data, number of posts within particular period of time by sources, number of user actions, number of views, number of likes, number of comments, number of dislikes, number of reports and any combination of thereof.

In an embodiment user or following user or contextual views or user connection or contact is presented with one content item at a time and display “Next” button dynamically for viewing next received content item i.e. display each time “Next” button at different positions of device or application or interface after pausing for random time, so it will provide guarantee to posting user sp. e.g. enterprise user to view posted content item(s) by each recipient users including followers, viewers, connections and targeted users or audience. In an embodiment with user permission capture viewing user's video to identify behavior of viewing user to watch or read or view photos or videos or text or one or more types of content items.

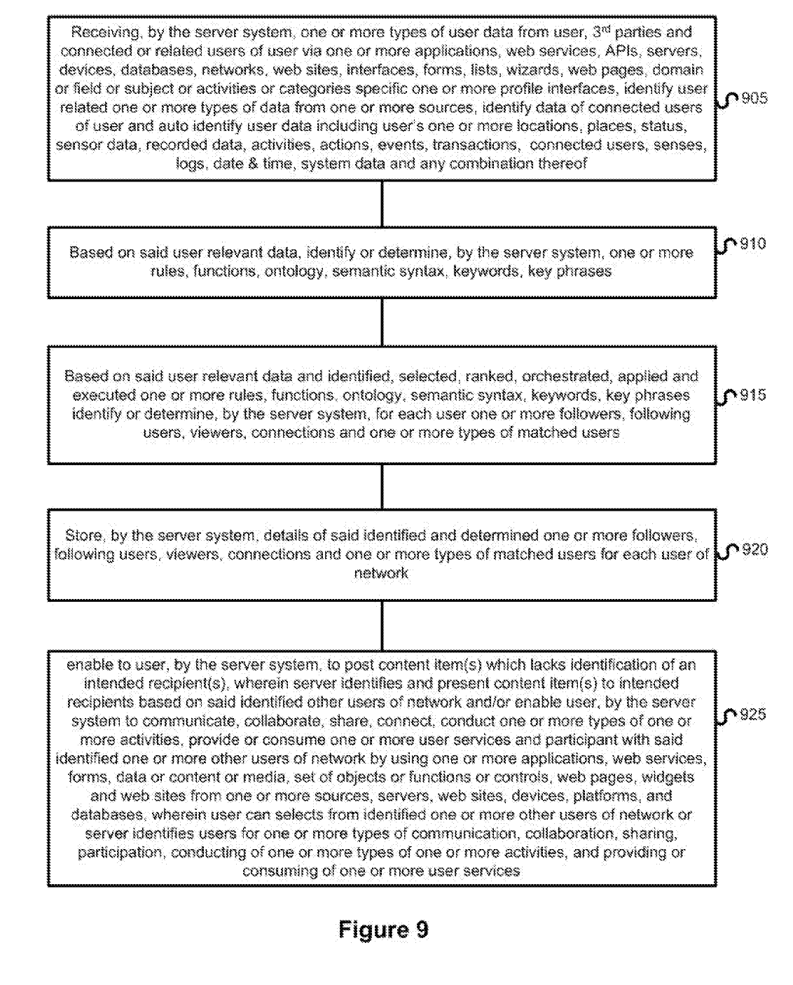

FIG. 9 is a flow chart illustrating example methods as well as specific algorithm operations that a processor may configure to perform with appropriate programming. For example in 905, receiving, by the server system, one or more types of user data from user, 3rd parties and connected or related users of user via one or more applications, web services, APIs, servers, devices, databases, networks, web sites, interfaces, forms, lists, wizards, web pages, domain or field or subject or activities or categories specific one or more profile interfaces, identify user related one or more types of data from one or more sources, identify data of connected users of user and auto identify user data including user's one or more locations, places, status, sensor data, recorded data, activities, actions, events, transactions, connected users, senses, logs, date & time, system data and any combination thereof.

In 910, based on said user relevant data, identify or determine, by the server system, one or more rules, functions, ontology, semantic syntax, keywords, key phrases

In 915, based on said user relevant data and identified, selected, ranked, orchestrated, applied and executed one or more rules, functions, ontology, semantic syntax, semantic matching algorithms, keywords, key phrases identify or determine, by the server system, for each user one or more followers, following users, viewers, connections and one or more types of matched users

In 920, store, by the server system, details of said identified and determined one or more followers, following users, viewers, connections and one or more types of matched users for each user of network

In 925, enable to user, by the server system, to post content item(s) which lacks identification of an intended recipient(s), wherein server identifies and present content item(s) to intended recipients based on said identified other users of network and/or enable user, by the server system to communicate, collaborate, share, connect, conduct one or more types of one or more activities, provide or consume one or more user services and participant with said identified one or more other users of network by using one or more applications, web services, forms, data or content or media, set of objects or functions or controls, web pages, widgets and web sites from one or more sources, servers, web sites, devices, platforms, and databases, wherein user can selects from identified one or more other users of network or server identifies users for one or more types of communication, collaboration, sharing, participation, conducting of one or more types of one or more activities, and providing or consuming of one or more user services

It is contemplated for embodiments described herein to extend to individual elements and concepts described herein, independently of other concepts, ideas or system, as well as for embodiments to include combinations of elements recited anywhere in this application. Although embodiments are described in detail herein with reference to the accompanying drawings, it is to be understood that the invention is not limited to those precise embodiments. As such, many modifications and variations will be apparent to practitioners skilled in this art. Accordingly, it is intended that the scope of the invention be defined by the following claims and their equivalents. Furthermore, it is contemplated that a particular feature described either individually or as part of an embodiment can be combined with other individually described features, or parts of other embodiments, even if the other features and embodiments make no mentioned of the particular feature. Thus, the absence of describing combinations should not preclude the inventor from claiming rights to such combinations.

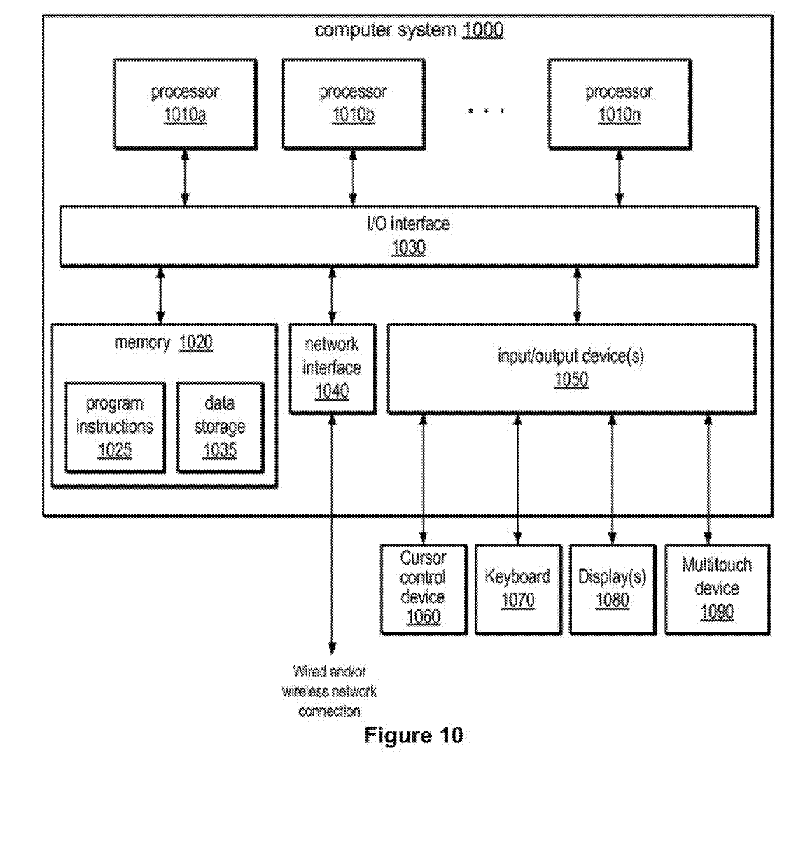

Various components of embodiments of methods as illustrated and described in the accompanying description may be executed on one or more computer systems, which may interact with various other devices. One such computer system is illustrated by FIG. 10. In different embodiments, computer system 1000 may be any of various types of devices, including, but not limited to, a personal computer system, desktop computer, laptop, notebook, or notebook computer, mainframe computer system, handheld computer, workstation, network computer, a camera, a set top box, a mobile device, a consumer device, video game console, handheld video game device, application server, storage device, a peripheral device such as a switch, modem, router, or in general any type of computing or electronic device.

In the illustrated embodiment, computer system 1000 includes one or more processors 1010 coupled to a system memory 1020 via an input/output (I/O) interface 1030. Computer system 1000 further includes a network interface 1040 coupled to I/O interface 1030, and one or more input/output devices 1050, such as cursor control device 1060, keyboard 1070, multitouch device 1090, and display(s) 1080. In some embodiments, it is contemplated that embodiments may be implemented using a single instance of computer system 1000, while in other embodiments multiple such systems, or multiple nodes making up computer system 1000, may be configured to host different portions or instances of embodiments. For example, in one embodiment some elements may be implemented via one or more nodes of computer system 1000 that are distinct from those nodes implementing other elements.

In various embodiments, computer system 1000 may be a uniprocessor system including one processor 1010, or a multiprocessor system including several processors 1010 (e.g., two, four, eight, or another suitable number). Processors 1010 may be any suitable processor capable of executing instructions. For example, in various embodiments, processors 1010 may be general-purpose or embedded processors implementing any of a variety of instruction set architectures (ISAs), such as the x86, PowerPC, SPARC, or MIPS ISAs, or any other suitable ISA. In multiprocessor systems, each of processors 1010 may commonly, but not necessarily, implement the same ISA.

In some embodiments, at least one processor 1010 may be a graphics processing unit. A graphics processing unit or GPU may be considered a dedicated graphics-rendering device for a personal computer, workstation, game console or other computing or electronic device. Modern GPUs may be very efficient at manipulating and displaying computer graphics, and their highly parallel structure may make them more effective than typical CPUs for a range of complex graphical algorithms. For example, a graphics processor may implement a number of graphics primitive operations in a way that makes executing them much faster than drawing directly to the screen with a host central processing unit (CPU). In various embodiments, the methods as illustrated and described in the accompanying description may be implemented by program instructions configured for execution on one of, or parallel execution on two or more of, such GPUs. The GPU(s) may implement one or more application programmer interfaces (APIs) that permit programmers to invoke the functionality of the GPU(s). Suitable GPUs may be commercially available from vendors such as NVIDIA Corporation, ATI Technologies, and others.

System memory 1020 may be configured to store program instructions and/or data accessible by processor 1010. In various embodiments, system memory 1020 may be implemented using any suitable memory technology, such as static random access memory (SRAM), synchronous dynamic RAM (SDRAM), nonvolatile/Flash-type memory, or any other type of memory. In the illustrated embodiment, program instructions and data implementing desired functions, such as those for methods as illustrated and described in the accompanying description, are shown stored within system memory 1020 as program instructions 1025 and data storage 1035, respectively. In other embodiments, program instructions and/or data may be received, sent or stored upon different types of computer-accessible media or on similar media separate from system memory 1020 or computer system 1000. Generally speaking, a computer-accessible medium may include storage media or memory media such as magnetic or optical media, e.g., disk or CD/DVD-ROM coupled to computer system 1000 via I/O interface 1030. Program instructions and data stored via a computer-accessible medium may be transmitted by transmission media or signals such as electrical, electromagnetic, or digital signals, which may be conveyed via a communication medium such as a network and/or a wireless link, such as may be implemented via network interface 1040.

In one embodiment, I/O interface 1030 may be configured to coordinate I/O traffic between processor 1010, system memory 1020, and any peripheral devices in the device, including network interface 1040 or other peripheral interfaces, such as input/output devices 1050. In some embodiments, I/O interface 1030 may perform any necessary protocol, timing or other data transformations to convert data signals from one component (e.g., system memory 1020) into a format suitable for use by another component (e.g., processor 1010). In some embodiments, I/O interface 1030 may include support for devices attached through various types of peripheral buses, such as a variant of the Peripheral Component Interconnect (PCI) bus standard or the Universal Serial Bus (USB) standard, for example. In some embodiments, the function of I/O interface 1030 may be split into two or more separate components, such as a north bridge and a south bridge, for example. In addition, in some embodiments some or all of the functionality of I/O interface 1030, such as an interface to system memory 1020, may be incorporated directly into processor 1010.

Network interface 1040 may be configured to allow data to be exchanged between computer system 1000 and other devices attached to a network, such as other computer systems, or between nodes of computer system 1000. In various embodiments, network interface 1040 may support communication via wired and/or wireless general data networks, such as any suitable type of Ethernet network, for example; via telecommunications/telephony networks such as analog voice networks or digital fiber communications networks; via storage area networks such as Fiber Channel SANs, or via any other suitable type of network and/or protocol.

Input/output devices 1050 may, in some embodiments, include one or more display terminals, keyboards, keypads, touchpads, scanning devices, voice or optical recognition devices, or any other devices suitable for entering or retrieving data by one or more computer system 1000. Multiple input/output devices 1050 may be present in computer system 1000 or may be distributed on various nodes of computer system 1000. In some embodiments, similar input/output devices may be separate from computer system 1000 and may interact with one or more nodes of computer system 1000 through a wired and/or wireless connection, such as over network interface 1040.

As shown in FIG. 10, memory 1020 may include program instructions 1025, configured to implement embodiments of methods as illustrated and described in the accompanying description, and data storage 1035, comprising various data accessible by program instructions 1025. In one embodiment, program instruction 1025 may include software elements of methods as illustrated and described in the accompanying description. Data storage 1035 may include data that may be used in embodiments. In other embodiments, other or different software elements and/or data may be included.

Those skilled in the art will appreciate that computer system 1000 is merely illustrative and is not intended to limit the scope of methods as illustrated and described in the accompanying description. In particular, the computer system and devices may include any combination of hardware or software that can perform the indicated functions, including computers, network devices, internet appliances, PDAs, wireless phones, pagers, etc. Computer system 1000 may also be connected to other devices that are not illustrated, or instead may operate as a stand-alone system. In addition, the functionality provided by the illustrated components may in some embodiments be combined in fewer components or distributed in additional components. Similarly, in some embodiments, the functionality of some of the illustrated components may not be provided and/or other additional functionality may be available.

Those skilled in the art will also appreciate that, while various items are illustrated as being stored in memory or on storage while being used, these items or portions of them may be transferred between memory and other storage devices for purposes of memory management and data integrity. Alternatively, in other embodiments some or all of the software components may execute in memory on another device and communicate with the illustrated computer system via inter-computer communication. Some or all of the system components or data structures may also be stored (e.g., as instructions or structured data) on a computer-accessible medium or a portable article to be read by an appropriate drive, various examples of which are described above. In some embodiments, instructions stored on a computer-accessible medium separate from computer system 1000 may be transmitted to computer system 1000 via transmission media or signals such as electrical, electromagnetic, or digital signals, conveyed via a communication medium such as a network and/or a wireless link. Various embodiments may further include receiving, sending or storing instructions and/or data implemented in accordance with the foregoing description upon a computer-accessible medium. Accordingly, the present invention may be practiced with other computer system configurations.

Various embodiments may further include receiving, sending or storing instructions and/or data implemented in accordance with the foregoing description upon a computer-accessible medium. Generally speaking, a computer-accessible medium may include storage media or memory media such as magnetic or optical media, e.g., disk or DVD/CD-ROM, volatile or non-volatile media such as RAM (e.g. SDRAM, DDR, RDRAM, SRAM, etc.), ROM, etc., as well as transmission media or signals such as electrical, electromagnetic, or digital signals, conveyed via a communication medium such as network and/or a wireless link.

The various methods as illustrated in the Figures and described herein represent examples of embodiments of methods. The methods may be implemented in software, hardware, or a combination thereof. The order of method may be changed, and various elements may be added, reordered, combined, omitted, modified, etc. Various modifications and changes may be made as would be obvious to a person skilled in the art having the benefit of this disclosure. It is intended that the invention embrace all such modifications and changes and, accordingly, the above description to be regarded in an illustrative rather than a restrictive sense.

In an embodiment a program is written as a series of human understandable computer instructions that can be read by a compiler and linker, and translated into machine code so that a computer can understand and run it. A program is a list of instructions written in a programming language that is used to control the behavior of a machine, often a computer (in this case it is known as a computer program).A programming language's surface form is known as its syntax. Most programming languages are purely textual; they use sequences of text including words, numbers, and punctuation, much like written natural languages. On the other hand, there are some programming languages which are more graphical in nature, using visual relationships between symbols to specify a program. In computer science, the syntax of a computer language is the set of rules that defines the combinations of symbols that are considered to be a correctly structured document or fragment in that language. This applies both to programming languages, where the document represents source code, and markup languages, where the document represents data. The syntax of a language defines its surface form. Text-based computer languages are based on sequences of characters, while visual programming languages are based on the spatial layout and connections between symbols (which may be textual or graphical or flowchart(s)). Documents that are syntactically invalid are said to have a syntax error. Syntax—the form—is contrasted with semantics—the meaning. In processing computer languages, semantic processing generally comes after syntactic processing, but in some cases semantic processing is necessary for complete syntactic analysis, and these are done together or concurrently. In a compiler, the syntactic analysis comprises the frontend, while semantic analysis comprises the backend (and middle end, if this phase is distinguished). There are millions of possible combinations, sequences, ordering, permutations & formations of inputs, interpretations, and outputs or outcomes of set of instructions of standardized or specialized or generalized or structured or functional or object oriented programming language(s).

The present invention has been described in particular detail with respect to a limited number of embodiments. Those of skill in the art will appreciate that the invention may additionally be practiced in other embodiments. First, the particular naming of the components, capitalization of terms, the attributes, data structures, or any other programming or structural aspect is not mandatory or significant, and the mechanisms that implement the invention or its features may have different names, formats, or protocols. Furthermore, the system may be implemented via a combination of hardware and software, as described, or entirely in hardware elements. Also, the particular division of functionality between the various system components described herein is merely exemplary, and not mandatory; functions performed by a single system component may instead be performed by multiple components, and functions performed by multiple components may instead performed by a single component. Additionally, although the foregoing embodiments have been described in the context of a social network website, it will apparent to one of ordinary skill in the art that the invention may be used with any social network service, even if it is not provided through a website. Any system that provides social networking functionality can be used in accordance with the present invention even if it relies, for example, on e-mail, instant messaging or any other form of peer-to-peer communications, or any other technique for communicating between users. Systems used to provide social networking functionality include a distributed computing system, client-side code modules or plug-ins, client-server architecture, a peer-to peer communication system or other systems. The invention is thus not limited to any particular type of communication system, network, protocol, format or application.

The foregoing description of the embodiments of the invention has been presented for the purpose of illustration; it is not intended to be exhaustive or to limit the invention to the precise forms disclosed. Persons skilled in the relevant art can appreciate that many modifications and variations are possible in light of the above disclosure.

Some portions of this description describe the embodiments of the invention in terms of algorithms and symbolic representations of operations on information. These algorithmic descriptions and representations are commonly used by those skilled in the data processing arts to convey the substance of their work effectively to others skilled in the art. These operations, while described functionally, computationally, or logically, are understood to be implemented by computer programs or equivalent electrical circuits, microcode, or the like. Furthermore, it has also proven convenient at times, to refer to these arrangements of operations as modules, without loss of generality. The described operations and their associated modules may be embodied in software, firmware, hardware, or any combinations thereof.

Any of the steps, operations, or processes described herein may be performed or implemented with one or more hardware or software modules, alone or in combination with other devices. In one embodiment, a software module is implemented with a computer program product comprising a computer-readable medium containing computer program code, which can be executed by a computer processor for performing any or all of the steps, operations, or processes described.

Embodiments of the invention may also relate to an apparatus for performing the operations herein. This apparatus may be specially constructed for the required purposes, and/or it may comprise a general-purpose computing device selectively activated or reconfigured by a computer program stored in the computer. Such a computer program may be stored in a tangible computer readable storage medium or any type of media suitable for storing electronic instructions, and coupled to a computer system bus. Furthermore, any computing systems referred to in the specification may include a single processor or may be architectures employing multiple processor designs for increased computing capability.

Embodiments of the invention may also relate to a computer data signal embodied in a carrier wave, where the computer data signal includes any embodiment of a computer program product or other data combination described herein. The computer data signal is a product that is presented in a tangible medium or carrier wave and modulated or otherwise encoded in the carrier wave, which is tangible, and transmitted according to any suitable transmission method.

Finally, the language used in the specification has been principally selected for readability and instructional purposes, and it may not have been selected to delineate or circumscribe the inventive subject matter. It is therefore intended that the scope of the invention be limited not by this detailed description, but rather by any claims that issue on an application based here on. Accordingly, the disclosure of the embodiments of the invention is intended to be illustrative, but not limiting, of the scope of the invention, which is set forth in the following claims.

I claim:

1. A computer-implemented method comprising:
a) identify or determine, by the server system, each user specific other users of network including followers, following users, viewers, group members, connections, contacts, domain or subject specific contextual users, participants for conducting one or more types of communications, collaborations, sharing, activities, actions, events, tasks & transactions, provider or consumer of user services, wherein user is not connected with or not manually following to said identified other users of network previously or mutually connected or mutually not connected with each other;
b) store, by the server system, each user specific said one or more types of identified other users of network; and
c) enable user, by the server system, to post content item(s) which lacks identification of an intended recipient(s), wherein server identifies and present content item(s) to intended recipients based on said identified other users of network and/or enable user, by the server system to communicate, collaborate, share, connect, conduct or participate with one or more types of one or more activities, actions, events & transactions, and provide or consume one or more user services with/from/to said identified one or more other users of network.

2. The method of claim 1, wherein present one or more types of one or more content items or media including text, link, photo, image, video, voice, location information, documents or file, attachment and any combination thereof to intended recipients comprises followers, viewers, contacts identified or determined by the server system or stored by the server system at database(s).

3. The method of claim 1, wherein identify or determine, by the server system, each user specific other users of network based on user data, wherein user data comprise user profile including age, gender, interest, school, college, employer, company, skills, languages, education, qualifications, income range, habits, religion, height, weight, cast & like, user activities, actions, events, transactions, senses, interactions, behavior, interacted entities, locations, places, contacts or connections, status, structured status, key phrases, keywords, categories, preferences, shared contents, references, viewed contents, subscribed contents, filled domain or subject or requirement or activities specific forms, one or more types of lists including products and services using or like to use and privacy settings.

4. The method of claim 1, wherein broadcast request comprise one or more type of content or media and associate one or more target criteria for matching of content, posting or broadcasting user data and one or more associated target criteria of posting user with user data of other users of network, wherein posting or communicating target criteria comprise one or more keywords, categories, types, locations, places, age range, gender, entity names & types, interests, languages, include or exclude IP address, destinations & one or more type of criteria and user data comprise user profile, logged activities, actions, events, transactions, locations, places, status, preferences, privacy settings, search query, keywords, past views of contents.

5. The method of claim 1, wherein enable server system to update each user's followers, following users, viewers or prospective viewers, prospective connections or contacts and one or more types or categories of matched in the event of one or more updates in one or more users of network's user data provided by user, contacts or connections of users, 3^{rd} parties, and auto identified by server system, wherein at particular interval of period of time or based on user's current or selected one or more locations, places, activities, actions, events & transactions alerting or notifying or make compulsory for each user to update user profile, requested one or more types of information and user data within particular period of time and in the event of providing of requested user data by user, allowing user to access system.

6. The method of claim 1, wherein displaying one or more fields or sub-filed(s) specific, one or more metadata of one or more fields or sub-filed(s) specific, one or more values of one or more fields or sub-filed(s) and any combination thereof specific number of prospective followers, following users, viewers, connections or contacts, possible average or estimated reactions and contextual one or more types of matched users of network.

7. The method of claim 1, wherein enabling user and user related server identified or determined contextual or matched one or more types of one or more users including one or more followers, following users, viewers, and connections to communicate, collaborate, share, conduct or participate with one or more activities, actions, events & transactions and provide or consume services by using one or more types of one or more applications, interfaces, user actions, widgets, set of controls, objects, web sites, web pages and web services or user services including real-time chat, instant messaging, collaboration application, mutual following, and invite to connect.

8. The method of claim 1, wherein enable following or un-following, followers and broadcasting or providing or presenting contents based on rules, policies, privacy settings, preferences and server rules & settings, wherein one or more rules including not allowing user to manually un-follow sources, allowing user to manually follow to contacts or connected users only including phone contacts, email addresses via email accounts, and social friends or connections, limit maximum numbers of auto followers based on number of following users and number of followers, limit number of maximum content items received or presented to user from all or each sources within particular period of time based on number of followers of user, daily engagement or number of viewing of content items within particular period of time, bookmarked or liked or ranked sources or sources of liked or ranked contents, user contacts, allow user to set maximum number of content item within particular period of time including (per minute, hour, daily, monthly) or time ranges from all or one or more selected or particular or categories of sources, limit maximum number of posting of content items within particular period of time, limit receiving of maximum number of content items from all or particular or one or more selected sources or category or keyword(s) or field specific sources, allow to un-follow after reaching particular number of following users or sources, fill or provide value(s) of particular number of field(s) of profile in particular interval of period of time, ratio of followers and following, enable user to un-follow one or more sources including enable to un-follow one or more sources by permitted users only, enable to un-follow one or more sources based on maximum limits of particular number of un-following of sources permitted within particular duration, request server to un-follow one or more sources with reason(s), report one or more sources as spam or inappropriate content(s), the server system is enable to auto un-follow user(s) to one or more followed sources based on updated user data, number of posts within particular period of time by sources, number of user actions, number of views, number of likes, number of comments, number of dislikes, number of reports and any combination of thereof.

9. A computerized system for user to user posting and viewing of contents in a network environment, the system comprise:
providing at least one processor having computer-readable program code stored therein that, when executed by the at least one processor, causes the processor to perform the following system steps comprising:
a) the server system program code portion configured to identify or determine each user specific other users of network including followers, following users, viewers, group members, connections, contacts, domain or subject specific contextual users, participants for conducting one or more types of communications, collaborations, sharing, activities, actions, events, tasks & transactions, provider or consumer of user services, wherein user is not connected with or not manually following to said identified other users of network previously or mutually connected or mutually not connected with each other;
b) the server system program code portion configured to store each user specific said one or more types of identified other users of network; and
c) the server system program code portion configured to enable user to post content item(s) which lacks identification of an intended recipient(s), wherein server identifies and present content item(s) to intended recipients based on said identified other users of network and/or the server system program code portion configured to enable user to communicate, collaborate, share, connect, conduct or participate with one or more types of one or more activities, actions, events & transactions, and provide or consume one or more user services with/from/to said identified one or more other users of network.

10. The system of claim 9, wherein present one or more types of one or more content items or media including text, link, photo, image, video, voice, location information, documents or file, attachment and any combination thereof to intended recipients comprises followers, viewers, contacts identified or determined by the server system or stored by the server system at database(s).

11. The system of claim 9, wherein the server system configure to identify or determine each user specific other users of network based on user data, wherein user data comprise user profile including age, gender, interest, school, college, employer, company, skills, languages, education, qualifications, income range, habits, religion, height, weight, cast & like, user activities, actions, events, transactions, senses, interactions, behavior, interacted entities, locations, places, contacts or connections, status, structured status, key phrases, keywords, categories, preferences, shared contents, viewed contents, subscribed contents, filled domain or subject or requirement or activities specific forms, one or more types of lists including products and services using or like to use and privacy settings.

12. The system of claim 9, wherein broadcast request comprise one or more type of content or media and associate one or more target criteria for matching of content, posting or broadcasting user data and one or more associated target criteria of posting user with user data of other users of network, wherein posting or communicating target criteria comprise one or more keywords, categories, types, locations, places, age range, gender, entity names & types, interests, languages, include or exclude IP address, destinations & one or more type of criteria and user data comprise user profile, logged activities, actions, events, transactions, locations, places, status, preferences, privacy settings, search query, keywords, past views of contents.

13. The system of claim 9, wherein server system is enable to update each user's followers, following users, viewers or prospective viewers, prospective connections or contacts and one or more types or categories of matched in the event of one or more updates in one or more users of network's user data provided by user, contacts or connections of users, 3^{rd} parties, and auto identified by server system, wherein at particular interval of period of time or based on user's current or selected one or more locations, places, activities, actions, events & transactions alerting or notifying or make compulsory for each user to update user profile, requested one or more types of information and user data within particular period of time and in the event of providing of requested user data by user, allowing user to access system.

14. The system of claim 9, wherein display one or more fields or sub-filed(s) specific, one or more metadata of one or more fields or sub-filed(s) specific, one or more values of one or more fields or sub-filed(s) and any combination thereof specific number of prospective followers, following users, viewers, connections or contacts, possible average or estimated reactions and contextual one or more types of matched users of network.

15. The system of claim 9, wherein user and user related server identified or determined contextual or matched one or more types of one or more users including one or more followers, following users, viewers, and connections are enabled to communicate, collaborate, share, conduct or participate with one or more activities, actions, events & transactions and provide or consume services by using one or more types of one or more applications, interfaces, user actions, widgets, set of controls, objects, web sites, web pages and web services or user services including real-time chat, instant messaging, collaboration application, mutual following, and invite to connect.

16. The system of claim 9, wherein enable following or un-following, followers and broadcasting or providing or presenting contents based on rules, policies, privacy settings, preferences and server rules & settings, wherein one or more rules including not allowing user to manually un-follow sources, allowing user to manually follow to contacts or connected users only including phone contacts, email addresses via email accounts, and social friends or connections, limit maximum numbers of auto followers based on number of following users and number of followers, limit number of maximum content items received or presented to user from all or each sources within particular period of time based on number of followers of user, daily engagement or number of viewing of content items within particular period of time, bookmarked or liked or ranked sources or sources of liked or ranked contents, user contacts, allow user to set maximum number of content item within particular period of time including (per minute, hour, daily, monthly) or time ranges from all or one or more selected or particular or categories of sources, limit maximum number of posting of content items within particular period of time, limit receiving of maximum number of content items from all or particular or one or more selected sources or category or keyword(s) or field specific sources, allow to un-follow after reaching particular number of following users or sources, fill or provide value(s) of particular number of field(s) of profile in particular interval of period of time, ratio of followers and following, enable user to un-follow one or more sources including enable to un-follow one or more sources by permitted users only, enable to un-follow one or more sources based on maximum limits of particular number of un-following of sources permitted within particular duration, request server to un-follow one or more sources with reason(s), report one or more sources as spam or inappropriate content(s), the server system is enable to auto un-follow user(s) to one or more followed sources based on updated user data, number of posts within particular period of time by sources, number of user actions, number of views, number of likes, number of comments, number of dislikes, number of reports and any combination of thereof.

17. A computer-implemented method for facilitating user-to-user communication in a network environment, the method comprising:
a) receiving, by a server system from first computing devices on behalf of a plurality of users in the network environment, herein called “viewing users”, a corresponding plurality types of user data;
b) storing, by a server system each user related user data in a storage;
c) identifying, by a server system each user specific list of followers, following users, viewers and one or more types of contextual or matched users or sources based on user data and/or identified, associated, applied and executed one or more rules via rule base system, ontology, semantic syntax, semantic matching, contextual users or sources from pre-created categories of sources or users, user followed or subscribed or likes or requested sources, and user contacts or connections;
d) storing, by a server system in a storage each user specific said list of followers, following users, viewers and one or more types of contextual or matched users or sources;
e) receiving, by the server system from a second computing device on behalf of a user in the network environment, herein called the “broadcasting user”, a broadcast request or posting request to broadcast or post a specific item(s) of content, wherein the broadcast or posting request lacks identification of an intended recipient, and wherein the broadcast or posting request includes an identification of the broadcasting or posting user; and
f) determining or identifying, by the server system, in response to the broadcast request, based on identified or determined one or more intended recipients as applied to the broadcast request, any viewing users then eligible to receive the specific item of content(s).

18. The method of claim 17, wherein identify or determine, by the server system, each user specific other users of network based on user data, wherein user data comprise user profile including age, gender, interest, school, college, employer, company, skills, languages, education, qualifications, income range, habits, religion, height, weight, cast & like, user activities, actions, events, transactions, senses, interactions, behavior, interacted entities, locations, places, contacts or connections, status, structured status, key phrases, keywords, categories, preferences, shared contents, viewed contents, subscribed contents, filled domain or subject or requirement or activities specific forms, one or more types of lists including products and services using or like to use and privacy settings.

19. The method of claim 17, wherein broadcast request comprise one or more type of content or media and associate one or more target criteria, wherein matching of content and one or more associated target criteria of posting user with user data of other users of network, posting or communicating target criteria comprise one or more keywords, categories, types, locations, places, age range, gender, entity names & types, interests, languages, include or exclude IP address, destinations & one or more type of criteria and user data comprise user profile, logged activities, actions, events, transactions, locations, places, status, preferences, privacy settings, search query, keywords, past views of contents.

20. The method of claim 17, wherein The method of claim 1, wherein enable following or un-following, followers and broadcasting or providing or presenting contents based on rules, policies, privacy settings, preferences and server rules & settings, wherein one or more rules including not allowing user to manually un-follow sources, allowing user to manually follow to contacts or connected users only including phone contacts, email addresses via email accounts, and social friends or connections, limit maximum numbers of auto followers based on number of following users and number of followers, limit number of maximum content items received or presented to user from all or each sources within particular period of time based on number of followers of user, daily engagement or number of viewing of content items within particular period of time, bookmarked or liked or ranked sources or sources of liked or ranked contents, user contacts, allow user to set maximum number of content item within particular period of time including (per minute, hour, daily, monthly) or time ranges from all or one or more selected or particular or categories of sources, limit maximum number of posting of content items within particular period of time, limit receiving of maximum number of content items from all or particular or one or more selected sources or category or keyword(s) or field specific sources, allow to un-follow after reaching particular number of following users or sources, fill or provide value(s) of particular number of field(s) of profile in particular interval of period of time, ratio of followers and following, enable user to un-follow one or more sources including enable to un-follow one or more sources by permitted users only, enable to un-follow one or more sources based on maximum limits of particular number of un-following of sources permitted within particular duration, request server to un-follow one or more sources with reason(s), report one or more sources as spam or inappropriate content(s), the server system is enable to auto un-follow user(s) to one or more followed sources based on updated user data, number of posts within particular period of time by sources, number of user actions, number of views, number of likes, number of comments, number of dislikes, number of reports and any combination of thereof.
